(19) United States
(12) Patent Application Publication
(10) Pub. No.: US 2015/0378805 A1
(43) Pub. Date: Dec. 31, 2015

(54) MANAGEMENT SYSTEM AND METHOD FOR SUPPORTING ANALYSIS OF EVENT ROOT CAUSE

(71) Applicant: HITACHI, LTD., Tokyo (JP)

(72) Inventors: Kaori NAKANO, Tokyo (JP); Masataka NAGURA, Tokyo (JP); Takayuki NAGAI, Tokyo (JP)

(21) Appl. No.: 14/765,988

(22) PCT Filed: Nov. 29, 2013
(86) PCT No.: PCT/JP2013/082207

§ 371 Date: Aug. 5, 2015

(51) Int. Cl. G06F 11/07

(52) U.S. Cl. CPC G06F 11/079; G06F 11/0709; G06F 11/0751

(57) ABSTRACT

A plurality of multi-purpose diagnostic procedures are associated with a plurality of rules and defined using component types. The rules indicate an association between one or more condition events and a conclusion event. A management system specifies cause candidates based target rules associated with condition events related to the occurrence events, and specifies a multi-purpose diagnostic procedure in association with a target rule that is a basis of a selected cause candidate. The management system creates an expanded diagnostic procedure that is a diagnostic procedure to be performed on one or more management target components for specifying a more specific cause of the selected cause candidate or updating the certainty of the selected cause candidate based on the specified multi-purpose diagnostic procedure and configuration management information that is information about the configuration of a plurality of the management target components.

### TECHNICAL FIELD

The present invention generally relates to support analysis of a root cause of an event occurred on a management target component.

### BACKGROUND ART

In the case where an IT (Information Technology) system is managed, as described in PTL 1, for example, it is performed that an event to be a cause is detected among a plurality of failures or signs of the failures detected in the system. More specifically, in PTL 1, various failures on a management target apparatus or components configuring the management target apparatus are formed in events, and management software stores event occurrence information on an event DB (database). Moreover, the management software includes an analysis engine that analyzes cause-and-effect relations between a plurality of events occurred on the management target apparatus. The analysis engine makes access to a configuration management DB including configuration information about the management target apparatus, and recognizes the relationship between a plurality of components across one or a plurality of management target apparatuses on a path on a certain I/O (input/output) route as a single group called “a topology”. When an event is occurred, the analysis engine then applies a metarule formed of a predetermined conditional statement and an analysis result to topologies including a component on which the event is occurred, and builds an expansion rule to analyze failures on individual topologies. The expansion rule includes a conclusion event that possibly becomes a root cause and a condition event group that is caused by a conclusion event in the case where the conclusion event is occurred. More specifically, an event described in the THEN section of the rule is a conclusion event that possibly becomes a root cause and an event described in the IF section is a condition event. In the case where the condition event group of the expansion rule is matched with an event group detected, the analysis engine displays the conclusion event described in the expansion rule as a root cause of a plurality of failures occurred on the IT system. In the IT system, a failure occurred on a single apparatus sometimes triggers failures on a plurality of different apparatuses in a dependence relation in a chain reaction manner. A technique described in PTL 1 can identify a failure that is a propagation source out of a plurality of detected failures.

### CITATION LIST

### Patent Literature

[PTL 1] WO2013/046287

### SUMMARY OF INVENTION

### Technical Problem

Techniques that analyze the cause of a failure based on the pattern of events occurred on a component including the technique disclosed in PTL 1 can narrow down a failure to be the origin of a plurality of failures occurred on the IT system. However, there is sometimes the case where it is not enabled to specify a detailed cause enough to determine a failure restoration method using only the pattern of events occurred. Namely, there is the case where it is not enabled to specify a cause that triggers a failure to be the origin of a plurality of failures.

### Solution to Problem

A storage device stores configuration management information, a plurality of rules, and a plurality of multi-purpose diagnostic procedures. The configuration management information is information about the configuration of a plurality of the management target components. Each of a plurality of rules is a rule that indicates an association between one or more events corresponding to one or more condition events and a conclusion event to be a cause in the case where the one or more condition events are occurred. Each of a plurality of multi-purpose diagnostic procedures is associated with any one of a plurality of the rules, and is a multi-purpose diagnostic procedure that is defined using one or a plurality of component types and that does not depend on the management target component. The processor specifies one or more cause candidates based on one or more target rules that are one or more rules in association with one or more condition events related to one or more occurrence events (events that are occurred) in a plurality of the rules. The processor specifies a multi-purpose diagnostic procedure in association with a target rule that is a basis of a selected cause candidate in one or more cause candidates in a plurality of the multi-purpose diagnostic procedures. The processor creates an expanded diagnostic procedure that is a diagnostic procedure to be performed on one or more management target components for specifying a more specific cause of the selected cause candidate or updating the certainly of the selected cause candidate based on the specified multi-purpose diagnostic procedure and the configuration management information.

### Advantageous Effects of Invention

It is possible to expect more detailed or more accurate specification of a cause of one or more occurrence events.

### BRIEF DESCRIPTION OF DRAWINGS

FIG. 1 is the schematic outline of a first embodiment.

FIG. 2 is exemplary configurations of an IT system and a management computer according to the first embodiment.

FIG. 3 is an exemplary configuration of an apparatus table in a configuration management DB.

FIG. 4 is an exemplary configuration of an iSCSI disk table in the configuration management DB.

FIG. 5 is an exemplary configuration of a network I/F table in the configuration management DB.

FIG. 6 is an exemplary configuration of a switch port table in the configuration management DB.

FIG. 7 is an exemplary configuration of an iSCSI target table in the configuration management DB.

FIG. 8 is an exemplary configuration of a storage port table in the configuration management DB.

FIG. 9 is an exemplary configuration of a performance table.

FIG. 10 is an exemplary configuration of an event queue table.

FIG. 11A is an exemplary configuration of a metarule.

FIG. 11B is an exemplary configuration of an expansion rule.

FIG. 12 is an exemplary configuration of a metadiagnostic procedure.

FIG. 13 is an exemplary configuration of a topology condition.

FIG. 14 is exemplary configurations of metacollecting ways.

FIG. 15 is an exemplary configuration of an expanded diagnostic procedure.

FIG. 16 is exemplary configurations of expanded collecting ways.

FIG. 17 is a flowchart of an exemplary failure cause analysis process executed by a failure analysis program.

FIG. 18 is an exemplary event analysis result screen.

FIG. 19 is a flowchart of an exemplary process executed by a diagnostic procedure expansion program.

FIG. 20 is a flowchart of an exemplary process executed by a diagnostic procedure expansion program.

FIG. 21 is a flowchart of an exemplary process executed by a display program.

FIG. 22 is an exemplary diagnosis result screen.

FIG. 23 is an exemplary configuration of a metarule according to a second embodiment.

FIG. 24 is an exemplary configuration of an expansion rule according to the second embodiment.

FIG. 25 is an exemplary configuration of an expanded diagnostic procedure according to the second embodiment.

FIG. 26 is a flowchart of an exemplary failure cause analysis process executed by a failure analysis program according to the second embodiment.

### DESCRIPTION OF EMBODIMENTS

In the following description, reference is made to the accompanying drawings, which are a part of the disclosure, and the drawings illustrate exemplary embodiments that can embody the present invention, and do not impose limitations on the present invention. In the drawings, the same reference numerals and signs indicate the same components throughout the drawings. Moreover, the detailed description provides various exemplary embodiments. However, as described and illustrated below, it is noted that the present invention is not limited to the embodiments described and illustrated in the present specification and the embodiments can be developed in other known embodiments or embodiments to be known in future to a person skilled in the art.

Furthermore, in the detailed description below, various specific details are disclosed in order to fully understand the present invention. However, as apparent to a person skilled in the art, all the specific details are not necessarily required to implement the present invention. In order not to needlessly complicate the present invention in other situations, publicly known structures, materials, circuits, processes, and interfaces are not described in detail, and they are described and/or in block diagrams.

Moreover, a certain part of the detailed description below is indicated in algorithms and symbols of the internal operations of a computer. These descriptions and expressions in algorithms and symbols are a means used by a person skilled in the art familiar with data processing techniques to effectively tell his/her inventions to other persons skilled in the art. The algorithm means a series of defined steps to reach the desired final state or result. Steps to be executed in the present invention are requested to physically manipulate concrete amounts for achieving concrete results.

Generally, although not required, these amounts are in the forms of electrical signals or magnetic signals that can be subjected to manipulations including storage, transfer, coupling, and comparison. It is shown that these signals are often referred to as a bit, value, element, symbol, character, item, number, and instruction, for sample, for convenience because these signals can be theoretically used in common. However, it is noted that all the signals and the equivalents have to be associated with appropriate physical quantities and they are merely convenient labels attached to these physical quantities.

As apparent from the following description, the description using the terms “to process”, “to compute”, “to calculate”, “to judge”, and “to display”, for example, throughout the description of the present specification may include the operation and processes of another information processing apparatus that manipulates data expressed as physical (electronic) quantities in a computer system or in the register and the memory of the computer system and converts the data into other items of data similarly expressed as physical quantities in the memory or the register of the computer system or in other information storage apparatuses, information transmission apparatuses, or display devices, unless otherwise specified.

An apparatus that performs operations in the present specification may be specially built for necessary purposes, or the apparatus may include one or more multi-purpose computers selectively started or reconfigured by one or more computer programs. Such a computer program can be stored, for example, on a computer readable storage medium such as an optical disk, magnetic disk, read only memory, random access memory, solid device, and driver or a given medium suited to storing electronic information, which is, however, not limited thereto.

Algorithms and displays shown in the present specification are not substantially related to specific computers or other apparatuses. Various multi-purpose systems may be used together with programs and modules according to the teachings of the present specification. However, it is sometimes convenient to build an apparatus specialized for executing desired process steps. The structures of various these systems will be apparent from the description disclosed below. No description is made in the present invention on the premise of specific programming languages. It will be understood that various programming languages can be used to implement the teachings of the present invention as described below. The instructions of program languages can be executed using one or more processing apparatuses, including a central processing unit (CPU), processor, or controller, for example.

Moreover, in the following description, information will be described in the expressions “aaa table”, “aaa list”, “aaa DB”, “aaa queue”, and “aaa repository”, for example. However, these items of information may be expressed in structures other than data structures such as tables, lists, DBs, queues, and repositories. Therefore, an “aaa table”, “aaa list”, “aaa DB”, “aaa queue”, and “aaa repository, for example, can be called “aaa information” in order to indicate non dependence on data structures.

Furthermore, at least one expression of an “identifier”, “title”, “name”, and “ID” in describing elements. However, they are replaceable by each other, and a different type of identification information may be used instead of at least one of them or in addition to them.

In the following description, there is the case where a process is described as a “program” is used for a grammatical subject. However, since a program executes a process defined by a processor to execute the process using a memory and a communication port (a communication control device), the processor may be used for a grammatical subject in describing the process. Moreover, a process disclosed as a program is used for a grammatical subject may be processes performed by a computer such as a management computer. Furthermore, a part or all of a program may be implemented by dedicated hardware. In addition, various programs may be installed on a computer through a program distribution server or a computer readable storage medium.

It is noted that the management computer includes an input/output device. For an example of the input/output device, a display, keyboard, and pointer device can be considered. However, the input/output device may be devices other than them. Moreover, inputs and displays in the input/output device may be substituted in which a serial interface or Ethernet (registered trademark) interface is used as the input/output device for a substitution of the input/output device, the interface is coupled to a display computer including a display, keyboard, or pointer device, information for display is sent to the display computer or input information is received from the display computer, and then a display is shown on the display computer, or an input is accepted.

In the following, a set of one or more computers that manage an IT system (an information processing system) and display information for display is sometimes called a management system. In the case where the management computer displays information for display, the management computer may be a management system. The combination of the management computer and the display computer may be a management system. Moreover, processes equivalent to the management computer may be implemented using a plurality of computers in order to accelerate management processes or to improve reliability. In this case, a plurality of these computers may be a management system (including the display computer in the case where the display computer performs display). The expression “to display information for display” using the management computer may be that information for display is displayed on the display device included in the management computer, or may be that the management computer (a server, for example) sends information for display to a remote display computer (a client, for example).

Furthermore, in the following description, in the case where the description is made as the same types of elements are distinguished from each other, the reference numerals and signs of the elements are sometimes used, whereas in the case where the description is made as the same types of elements are not distinguished from each other, the common parent reference numerals and signs of the reference numerals and signs of the elements are sometimes used. For example, in the case where the description is made as servers are not distinguished from each other specifically, a server is denoted as a server 202, whereas in the case where the description is made as individual servers are distinguished from each other, servers are denoted as servers 202a and 202b.

### First Embodiment

### Outline of an Embodiment

As described in more detail below, according to a first embodiment, there are provided an apparatus, method, and computer program that derive diagnostic procedures for specifying a cause event of a failure occurred on an IT system and perform diagnosis to specify the cause event of the failure based on the diagnostic procedures.

According to the first embodiment, a management computer 201 is a computer that manages a plurality of management target apparatuses. For example, for types of the management target apparatuses, there is at least one of a computer (a server for example), a network device (an IP (Internet Protocol switch, router, or FC (Fibre Channel) switch, for example), and a storage device (a NAS (Network Attached Storage), for example). For logical or physical elements such as devices included in a single management target apparatus, there is at least one of a port, processor, stored source, physical storage device, program, virtual machine, logical volume (logical storage device), and RAID (Redundant Arrays of Inexpensive (Independent) Disks) group, for example. In the following, the management target apparatus and individual elements included in the management target apparatus are generically referred to as a “management target component”. Moreover, the management target apparatus can be called a node apparatus as well.

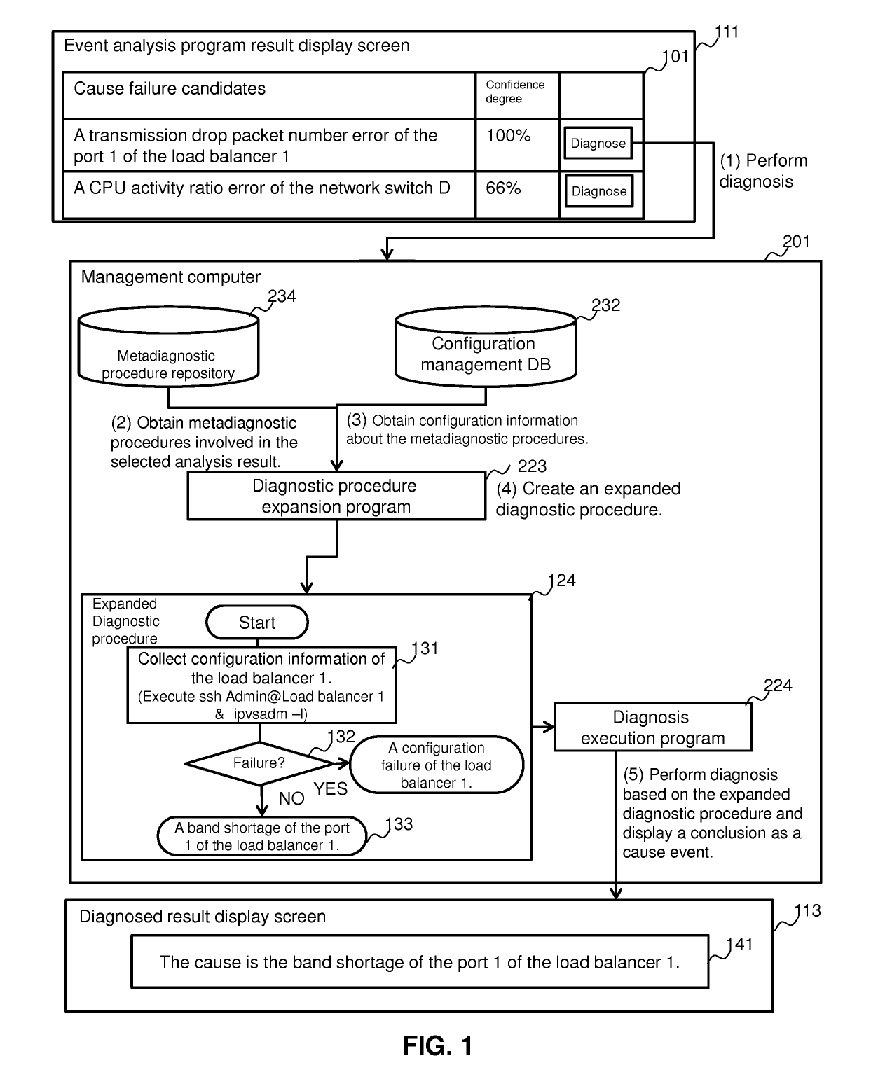

FIG. 1 is the schematic outline of the first embodiment.

An event analysis program result display screen 111 displays an event analysis result 101. The event analysis result 101 expresses a failure to be a propagation source of failures occurred on a plurality of apparatuses as cause failure candidates. The event analysis result 101 is a result derived by an event analysis program described later. The event analysis result 101 may be derived by the method disclosed in PTL 1, for example.

The management computer 201 includes a metadiagnostic procedure repository 234 that stores diagnostic procedures to specify the cause event of a failure on the IT system and a configuration management DB (database) 232 that stores configuration information about a management target component. Diagnostic procedures executed on a creation pattern in the IT system are described in metadiagnostic procedures stored on the metadiagnostic procedure repository 234. The configuration information stored on the configuration management DB 232 includes information about the management target components, coupling relation information expressing the coupling relation between the management target components, and dependence relation information expressing the dependence relation between the management target components.

In the case where a user or the management computer 201 selects a cause failure candidate from one or a plurality of cause failure candidates expressed on the event analysis result 101, the management computer 201 executes a diagnostic procedure expansion program 223 in order to perform more detailed analysis of the cause of a failure. The diagnostic procedure expansion program 223 obtains metadiagnostic procedures related to the event analysis result 101 from the metadiagnostic procedure repository 234. Subsequently, the diagnostic procedure expansion program 223 obtains configuration information about a management target component to which diagnosis has to be performed from the configuration management DB 232 based on the configuration pattern defined on the obtained metadiagnostic procedures and the selected cause failure candidate. The diagnostic procedure expansion program 223 then creates an expanded diagnostic procedure 124 from the obtained metadiagnostic procedures and the obtained configuration information. The expanded diagnostic procedure 124 includes an information collecting step 131 of collecting information necessary for diagnosis, a judgment step 132 of making a judgment based on the collected information, and a conclusion 133 indicating a failure cause event derived from the judgment result. A diagnosis execution program 224 executes the individual steps defined on the created expanded diagnostic procedure 124, considers the obtained conclusion to be a failure cause event on the IT system, and displays a diagnosed result 141 according to the failure cause event on a diagnosed result display screen 113.

According to the embodiment, when a plurality of failures is occurred on the IT system, a failure of the propagation source of a plurality of failures is narrowed down by event analysis, and the diagnostic procedures necessary to specify the cause of the occurrence of the propagation source failure are automatically expanded to perform diagnosis, so that the cause of the occurrence of the failure can be quickly specified.

Consequently, failure restoration measures can be quickly determined based on the specified cause event, and the downtime of the IT system can be shortened. Consequently, it is possible to reduce economic damage such as the loss of business opportunities occurred due to the halt of the IT system. More specifically, it is possible to analyze a failure difficult to specify the cause using only events such as a failure caused by a faulty configuration and a performance failure. For example, in the case where a performance failure is occurred on the IT system, it is possible that the event analysis program specifies a component (an apparatus and the element of the apparatus, for example) to be a bottleneck and then the diagnostic procedure expansion program 223 and the diagnosis execution program 224 estimate a cause why the component becomes a bottleneck. In this case, the bottleneck of the system failure is specified as well as the cause of the occurrence of the bottleneck is specified, and information to be the basis of determining failure restoration measures is increased. Thus, it is facilitated to determine one measure to perform out of a plurality of failure restoration measures against a single failure.

In the following, the first embodiment will be described in detail.

### <Configurations of IT System and Management Computer 201>

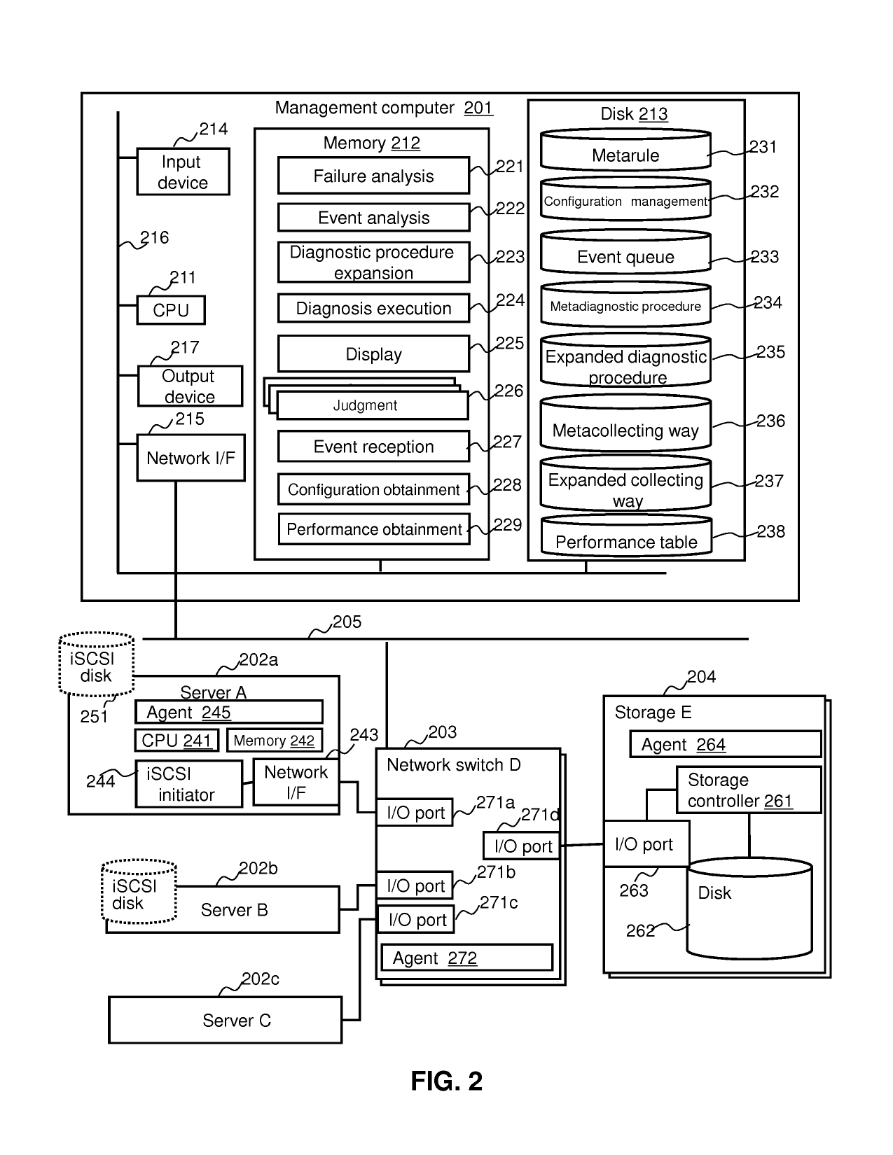

FIG. 2 is exemplary configurations of the IT system and the management computer 201 according to the first embodiment.

The management computer 201 is a computer that manages the IT system. The IT system includes one or more servers (or other computers) 202a, 202b, and 202c, one or more storage devices 204, and one or more network switches (other network devices like an IP switch) 203. The servers 202a, 202b, and 202c, the network switches 203, and the storage devices 204 are coupled to each other through a network 205 (the network switches 203 according to the example in FIG. 2) like a LAN (local area network) as they can communicate with each other.

The management computer 201 may be a multi-purpose computer that includes a CPU 211, a memory 212, a disk 213, an input device 214, an output device 217, and a network interface device (a network I/F) 215 and these devices are coupled to each other through a system bus 216. The disk 213 is a HDD (Hard Disk Drive), for example. However, other non-volatile storage devices like a SSD (Solid State Drive) may be adopted instead of the HDD. For the logical modules of the management computer 201, there are a failure analysis program 221, an event analysis program 222, a diagnostic procedure expansion program. 223, a diagnosis execution program 224, a display program 225, one or more judgment programs 226, an event reception program 227, a configuration obtainment program 228, and a performance obtainment program. 229, for example. One judgment program. 226 may be provided, or the judgment program 226 may be provided for individual judgments of the metadiagnostic procedures. Moreover, for items of data stored on the management computer 201, there are a metarule repository 231, a configuration management DB 232, an event queue table 233, a metadiagnostic procedure repository 234, an expanded diagnostic procedure repository 235, a metacollecting way repository 236, an expanded collecting way repository 237, and a performance table 238, for example. In the embodiment (and a second embodiment), the term “way” in “the metacollecting way” and “the expanded collecting way” may be replaced by the term “method”, “definition”, or “command”. The expanded diagnostic procedure repository 235 and the expanded collecting way repository 237 are storage repositories for reusing information once created, and may not be included in the management computer. Furthermore, the performance table 238 is a database that stores performance information about a management target component collected from the management target apparatus by the performance obtainment program 229. The performance obtainment program 229 and the performance table 238 are programs and information used for showing exemplary “diagnostic procedures” described in the embodiment, and may not be included in the management computer 201. In addition, it may be fine that the performance table 238 is not included in the management computer 201, management target apparatuses store information, and the management computer 201 makes access to management target apparatuses through the network 205 and obtains performance information when referring to performance information about a management target component.

The failure analysis program 221, the event analysis program 222, the diagnostic procedure expansion program 223, the diagnosis execution program 224, the display program 225, one or more the judgment programs 226, the event reception program. 227, the configuration obtainment program. 228, and the performance obtainment program 229 are stored on the memory 212, and executed by the CPU 211. The metarule repository 231, the configuration management DB 232, the event queue table 233, the metadiagnostic procedure repository 234, the expanded diagnostic procedure repository 235, the metacollecting way repository 236, the expanded collecting way repository 237, and the performance table 238 are stored on the disk 213. At least one program or at least one item of data of them may be stored on a different appropriate storage area to which the CPU 211 can refer.

The network I/F 215 obtains information about the components such as configuration information and performance information from management target apparatuses such as the server 202, the network switch 203, and the storage device 204 coupled to each other through the network 205. The output device 217 is a device that outputs (typically displays) information from the display program 225. The input device 214 is a device that inputs a user indication. For example, a keyboard and a pointer device can be used for the input device 214, and a display and a printer can be used for the output device 217, which however may be devices other than these devices.

The individual servers 202a, 202b, and 202c may be management target apparatuses on which that execute programs such as applications are executed. The server 202a may be a multi-purpose computer including a memory 242, a network I/F 243, and a CPU 246 coupled thereto. The server 202a may include a non-volatile storage device like a HDD in addition to the memory 242. The server 202a may include a monitoring agent (program) 245 that monitors the state of the server 202a and sends event information expressing an event to the management computer 201 through the network 205 in the case where a specific change in the state (an event) is detected. The CPU 241 may perform the monitoring agent 245. Notifying an event may be sending event information expressing the event. The server 202a may include an iSCSI (Internet Small Computer System Interface) initiator 244. For example, the server 202a can virtually use the iSCSI disk 251 like a local HDD, and this is implemented depending on the storage capacities of the iSCSI initiator 244 and the storage device 204. Instead of the iSCSI, or in addition to the iSCSI, different communication and storage protocols may be used. It is noted that the configuration of the server 202a is described, and the servers 202b and 202c may include the same configuration of the server 202a.

The individual storage devices 204 may be management target apparatuses that provide the storage capacity (the logical volume) for applications operating on the server 202 (or provide different purposes). The storage device 204 includes an I/O port 263, a disk 262, and a storage controller (a CPU, for example) 261 coupled thereto. There may be a plurality of the I/O ports 263. The disk 262 may be a single HDD, or may be a RAID group configured of a plurality of HDDs. However, a non-volatile storage device in the disk 262 may be different storage devices such as an SSD. In the embodiment, the storage device 204 may be configured so as to provide an iSCSI logical volume as a storage capacity to the servers 202a and 202b. Therefore, it may be fine that two servers 202a and 202b are coupled to the storage device 204 through the network switch 203 and the storage device 204 provides iSCSI logical volumes to the servers 202a and 202b. Moreover, the storage device 204 may include a monitoring agent (program) 264 that monitors the state of the storage device 204 and sends event information to the management computer 201. The storage controller 261 may perform the monitoring agent 264. Furthermore, it may be fine that the monitoring agent 245 of the server 202 can monitor the state of the storage device 204.

The network switch 203 includes ports 271a to 271d that receive data sent from the server 202 or the storage device 204, or send received data. Moreover, the network switch 203 may include a monitoring agent (program) 272 that monitors the state of the network switch 203 and sends event information to the management computer 201 through the network 205 in the case where a specific change in the state (an event) is detected. A CPU, not illustrated, in the network switch 203 may perform the monitoring agent 272. Alternatively, the monitoring agent 245 of the server 202 may monitor the state of the network switch 203.

### <Configuration Management DB>

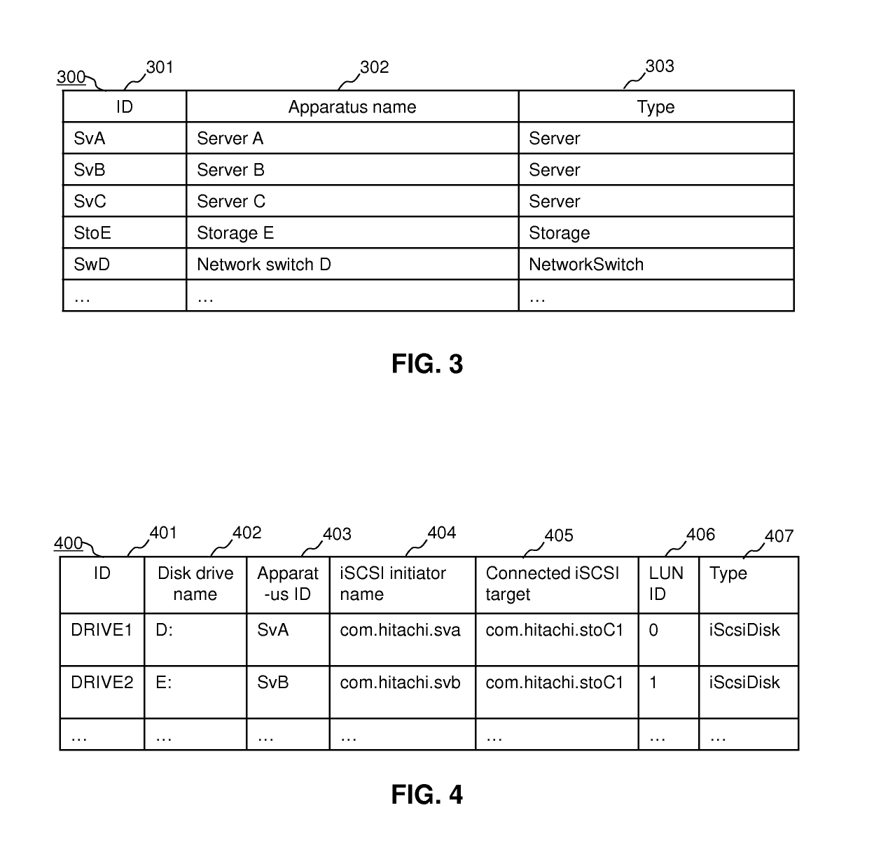

The configuration management DB 232 stores configuration information about a management target apparatus obtained from the monitoring agent, for example, by the configuration obtainment program 228. The configuration information includes information indicating coupling relation and dependence relation, for example, between management target components. Exemplary configuration information about the server 202, the network switch 203, and the storage device 204 are illustrated in FIGS. 3 to 9. It is noted that the configuration management DB 232 may not include apart of tables in FIG. 3 to FIG. 9, or may not include a part of items in at least one table. Moreover, the data expression formats and the data structures of items stored on the configuration management DB 232 may not the same as the expression formats and the data structures of data included in management target apparatuses. Moreover, in the case where the management computer 201 receives these items from a management target, the management computer 201 may receive these items according to the data structure and expression format of the management target apparatus. Furthermore, information on the tables of the configuration management DB 232 may be updated in association with a change in the configuration of the management target component. In the case where information on the tables of the configuration management DB 232 is updated, logs of the update may be stored as history information. The configuration management DB 232 in the past may be reconstituted based on the logs.

FIG. 3 is an exemplary configuration of an apparatus table in the configuration management DB 232.

The apparatus table 300 includes records individually for management target apparatuses, and the records individually include three fields, that is, an apparatus ID 301, an apparatus name 302, and a type 303. The ID 301 stores a value that uniquely identifies a management target apparatus. The apparatus name 302 stores a value that can uniquely identify the apparatus by the administrator. The type 303 stores an identifier indicating the type of the apparatus.

FIG. 4 is an exemplary configuration of an iSCSI disk table in the configuration management DB 232.

An iSCSI disk table 400 is a table indicating the configuration of the iSCSI disk 251 that the server 202 uses. The iSCSI disk table 400 includes records individually for the iSCSI disks 251, and the individual records include seven fields, that is, an ID 401, a disk drive name 402, an apparatus ID 403, an iSCSI initiator name 404, a connection destination iSCSI target 405, a LUN ID 406, and a type 407. The ID 401 stores a value that uniquely identifies the iSCSI disk (a management target component) 251. The disk drive name 402 stores a value that can uniquely identify the iSCSI disk 251 at the server 202. The apparatus ID 403 stores an identifier indicating the server 202 that uses the iSCSI disk 251. The iSCSI initiator name 404 stores an identifier of the network I/F 243 on the server 202 for use in communication with the storage device 204 on which the entity of the iSCSI disk 251 exists. The connection destination iSCSI target 405 stores an identifier of the I/O port 263 on the storage device 204 for use in communication with the storage device 204 on which the entity of the iSCSI disk 251 exists. The LUN ID 406 stores an identifier of the logical volume as the entity of the iSCSI disk 251 (the logical volume of the storage device 204). The type 407 stores an identifier indicating the type of the management target component (the iSCSI disk). For example, the record on the first line means the following. Namely, an iSCSI disk indicated by the disk drive name “D:” on a server identified by the ID “SvA” is identified by the ID “DRIVE1”, and the component type is “iScsIDisk”. The logical volume having the LUN ID 0 is provided from the storage device to the server through a server port (a port included in the server) indicated by the iSCSI initiator name com.hitachi.sva and a storage port indicated by the iSCSI target name com.hitachi.stoC1 (a port included in the storage device).

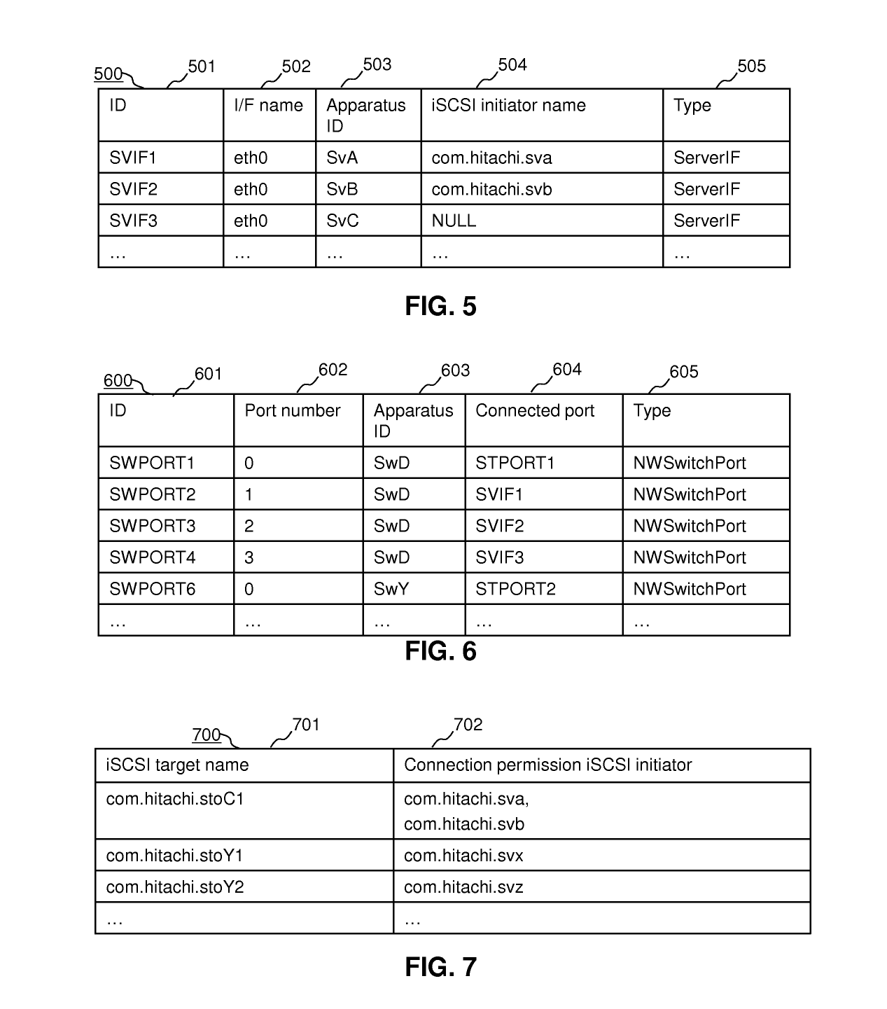

FIG. 5 is an exemplary configuration of a network I/F table in the configuration management DB 232.

A network I/F table 500 includes records individually for the networks I/F 243, and the records include five fields, that is, an ID 501, an I/F name 502, an apparatus ID 503, an iSCSI initiator name 504, and a type 505. The ID 501 stores a value that uniquely identifies the network I/F 243 (a management target component). The I/F name 502 stores a value to be an identifier of the network I/F 243 on the server 202. The apparatus ID 503 stores an identifier of the server 202 including the network I/F 243. The iSCSI initiator name 504 stores an identifier of the network I/F 243 on the server 202 for use in communication with the storage device on which the entity of the iSCSI disk exists. The type 505 stores an identifier indicating the type of the management target component. For example, the record on the first line means the following. The network I/F indicated by the I/F name “eth0” exists on the server identified by the ID “SvA”, and is identified by the ID “SVIF1”, the component type is “ServerIF”, and the iSCSI initiator name used as an identifier in communication with the storage device is “com.hitachi.sva”.

FIG. 6 is an exemplary configuration of a switch port table in the configuration management DB 232.

The switch port table 600 includes records individually for the I/O ports 271 included in the network switch 203, and the records include five fields, that is, an ID 601, a port number 602, an apparatus ID 603, a connection destination port 604, and a type 605. The ID 601 stores a value that uniquely identifies the I/O port 271 (a management target component). The port number 602 stores a value that uniquely identifies the I/O port 271 at the network switch 203. The apparatus ID 603 stores an identifier of the network switch 203 including the I/O port 271. The connection destination port 604 stores an identifier of the network I/F 243 of the server 202 coupled to the I/O port 271 or an identifier of the I/O port 263 of the storage device 204. In the case where the network switch 203 is coupled in multi stages, since data output from the network I/Fs of a plurality of the servers or the I/O port of the storage device is passed through the port of the network switch, a plurality of identifiers may be stored on the connection destination port 604. The type 605 stores an identifier indicating the type of a management target component. For example, the record on the first line means the following. The I/O port indicated by the number “0” is included in a network switch identified by the ID “SwD”, and is identified by the ID “SWPORT1”, the component type is “NWSwitchPort”, and the I/O port is coupled to the I/O port identified by “STPORT1”.

FIG. 7 is an exemplary configuration of an iSCSI target table in the configuration management DB 232.

An iSCSI target table 700 includes records individually for the iSCSI targets, and the records include two fields, that is, an iSCSI target name 701 and a connection permission iSCSI initiator 702. The iSCSI target name 701 stores an iSCSI target name individually included in the iSCSI targets. The connection permission iSCSI initiator 702 stores an iSCSI initiator name to be the identifier of the network I/F 243 on the server to which access is permitted to a logical volume belonging to the iSCSI target. For example, the record on the first line means the following. The network I/F 243 on the server identified by “com.hitachi.sva” and “com.hitachi.svb” are permitted to make access to a logical volume belonging to the iSCSI target identified by “com.hitachi.stoC1”.

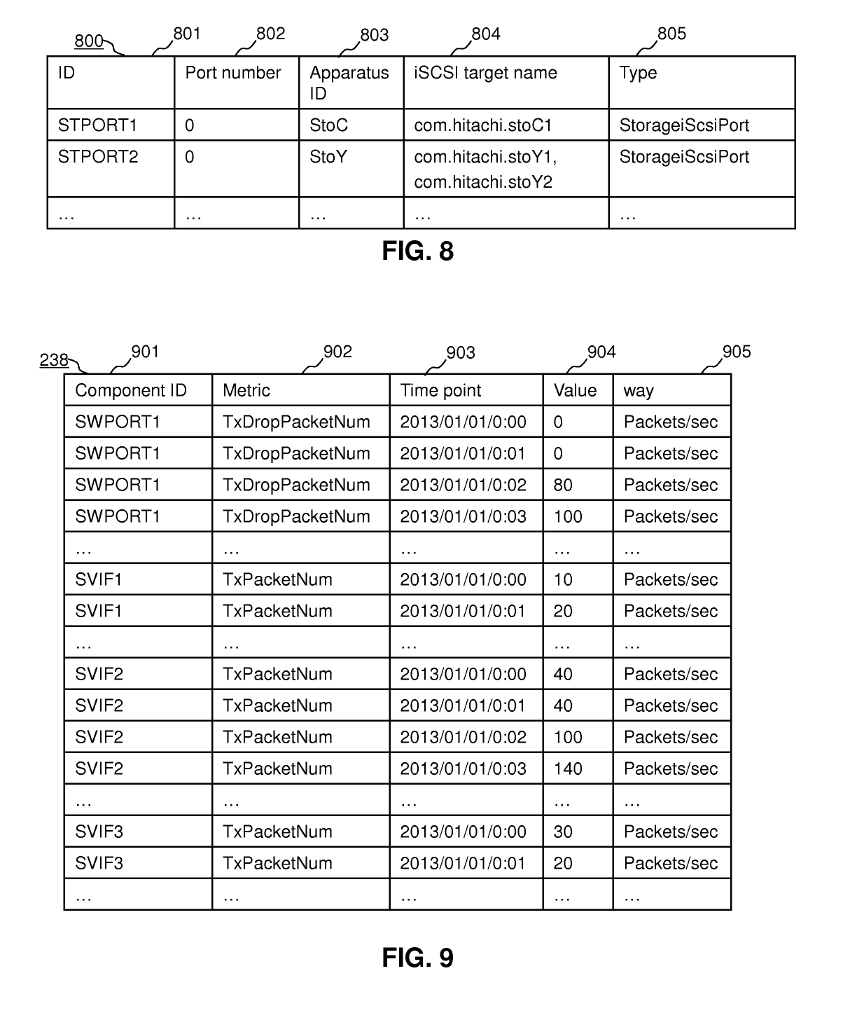

FIG. 8 is an exemplary configuration of a storage port table in the configuration management DB 232.

A storage port table 800 includes records individually for the I/O ports 263 included in the storage device 204, and the records include five fields, that is, an ID 801, a port number 802, an apparatus ID 803, an iSCSI target ID 804, and a type 805. The ID 801 stores a value that uniquely identifies the I/O port 263 (a management target component). The port number 802 stores a value that uniquely identifies the I/O port 263 on the storage device 204. The apparatus ID 803 stores an identifier of the storage device 204 including the I/O port 263. The iSCSI target 804 stores an identifier of an iSCSI target that uses the I/O port 263. The type 605 stores an identifier indicating the type of a management target component. For example, the record on the first line means the following. The I/O port indicated by the number “0” is included in the storage device identified by the ID “StoC”, and is identified by the ID “STPORT1”, the component type is “StorageiSCSIPort”, and the I/O port is used by the iSCSI target identified by “com.hitachi.stoC1”.

### <Performance Table>

The performance table 238 stores performance information about the management target component configuring the management target apparatus obtained by the performance obtainment program 229 from the monitoring agent, for example.

FIG. 9 is an exemplary configuration of the performance table 238.

The performance table 238 includes records individually for performance information, and the records include five fields, that is, a component ID 901, a metric 902, a time point 903, a value 904, and a unit 905. The component ID 901 stores a value that uniquely identifies a management target component which is the obtainment source of performance information. The metric 902 stores a value that identifies an observation item (a metric) of the performance of the management target component. The time point 903 stores a time point at which the performance of the management target component is observed. The time point is a unit for a year, month, and time point, which may be a coarser unit or a finer unit than a year, month, and time point. The value 904 stores a value that the performance of the management target component is observed. The unit 905 stores units for the observed value. For example, the record on the first line means the following. The performance “0 Packets/sec” is observed at 2013/01/01/0:00 for the observation item identified by “TxDropPacketNum” of a management component identified by the ID “SWPORT1” (here, a port 0 of a network switch D).

### <Event Queue Table>

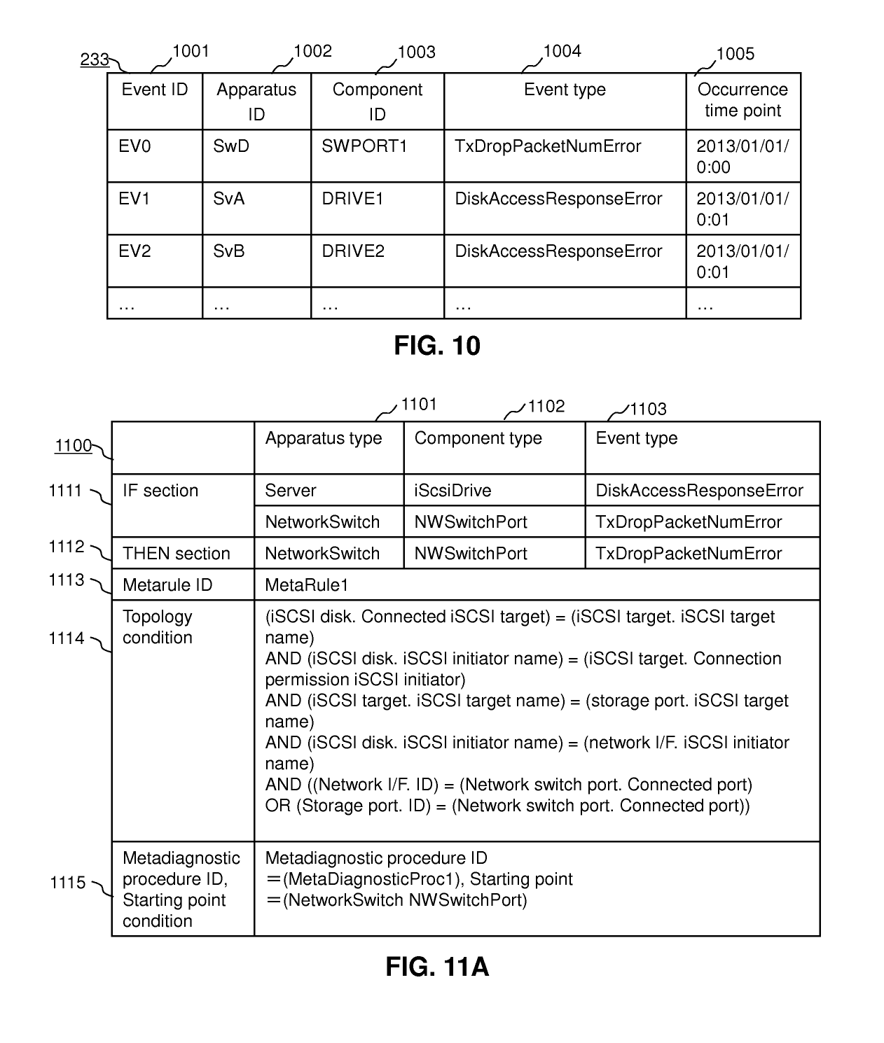

FIG. 10 is an exemplary configuration of the event queue table 233.

The event queue table 233 stores event information obtained from the monitoring agent of a management target apparatus, for example, by the event reception program 227. The event queue table 233 includes records individually for event information, and the records include five fields, that is, an event ID 1001, an apparatus ID 1002, a component ID 1003, an event type 1004, and an occurrence time point 1005.

The event ID 1001 stores an identifier that uniquely identifies event information. The apparatus ID 1002 stores an identifier that uniquely identifies a management target apparatus which is the obtainment source of event information. The component ID 203 stores an identifier that uniquely identifies a management target component which is the obtainment source of event information. The event type 1004 stores an identifier indicating the type of an event that is occurred on the management target component. The occurrence time point 1005 stores a time point at which the event is occurred (a time point included in the obtained event information). The occurrence time point 1005 may store a time point at which the management computer 201 receives event information. In the case where an event is not an event related to the element of an apparatus and is an event related to an apparatus itself, the value of the component ID 1003 may not be equal to the value of the apparatus ID 1002. For example, the record on the first line means the following. On the I/O port 273 whose component ID is SWPORT1 on the network switch 203 whose apparatus ID is SwD, “TxDropPacketNumError (a transmission drop packet number error)” is occurred at 2013/01/01/0:00.

### <Metarule Repository and Metarule>

The event analysis program 222 executes failure cause analysis. The failure cause analysis may be the same analysis described in PTL 1, for example. After narrowing down a failure to be the propagation source of a plurality of failures occurred on the IT system, the event analysis program 222 performs diagnosis in order to specify the cause of the occurrence of the failure to be the propagation source. The metarule is information for use when the event analysis program 222 performs analysis. The metarule is information indicating the corresponding relationship between the combination of events possibly occurred in a pattern of a certain topology (a group of one or a plurality of management target components existing on the route of a certain I/O) and a cause candidate for the failure in the case where these events are occurred at the same timing. In the first embodiment, a cause candidate defined by the metarule indicates a failure to be a propagation source of a system failure. The metarule includes information for identifying a metadiagnostic procedure for use in executing detailed diagnosis on the cause event of the failure indicated by the metarule and information about a management target component to be a starting point of a topology that is a diagnosis target. In the embodiment, the metarule is described in an IF-THEN format. However, the format may be other formats as long as a cause event of a system failure and an observation event (an observed event) caused by the cause event are described.

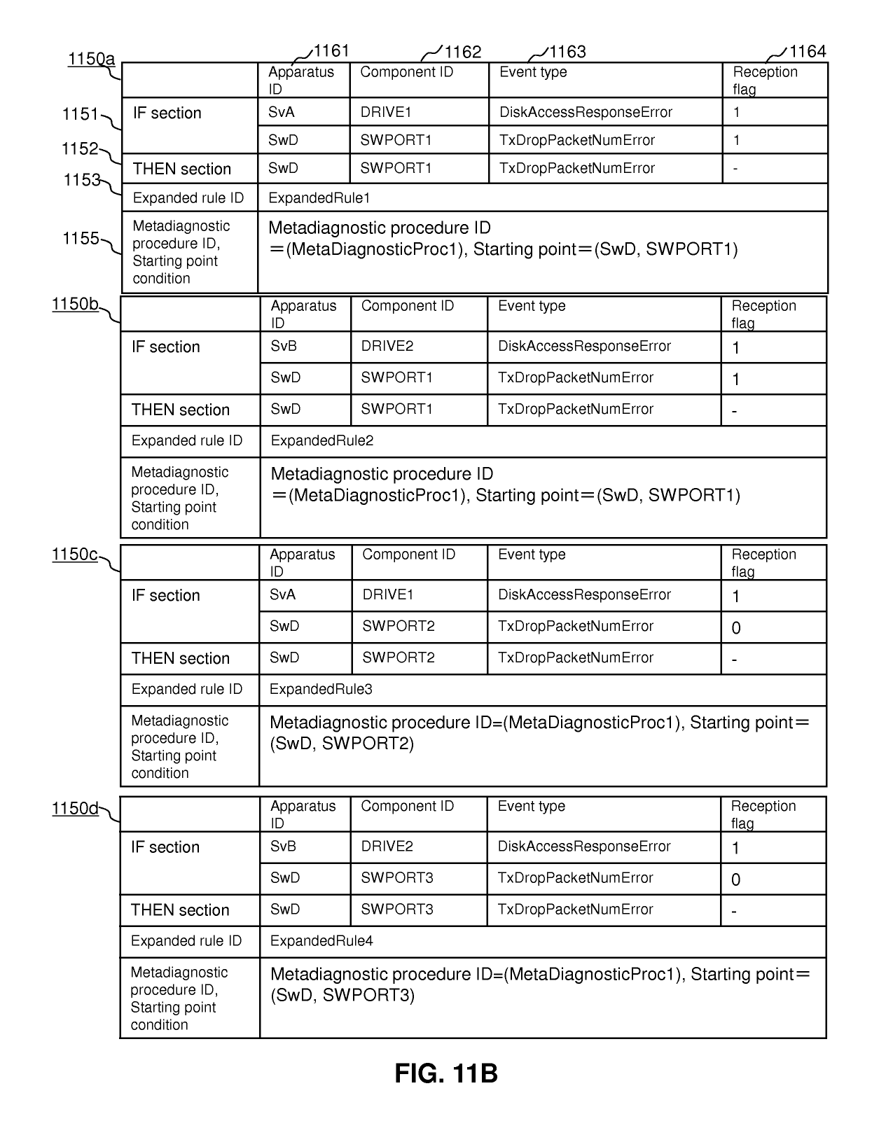

FIG. 11A is an exemplary configuration of the metarule 1100 that resides on the metarule repository 231.

Generally, the rule can be split into two sections (two fields), that is, a first portion called an “IF” section 1111 and a second portion called a “THEN” section 1112. The IF section 1111 may include one or more condition elements.

In the case where the event (the condition event) of the IF section 1111 is detected, the metarule 1100 indicates that the event (the conclusion event) of the THEN section 1112 is a cause candidate for a failure. Therefore, when the status of the management target component expressed by the THEN section 1112 becomes normal, it can be expected that a problem expressed by the IF section 1111 will be solved.

In the embodiment, the event analysis program 222 takes an event expressed by event information stored on the event queue table 233 illustrated in FIG. 10 as an observation event, and analyzes it. To this end, the IF section 1111 includes entries individually for condition elements, and the entries include an apparatus type 1101, a component type 1102, and an event type 1103. Namely, management target apparatuses and the elements of the management target apparatuses are sorted into several types on the management computer 201. The condition element of the IF section 1111 indicates that a state indicated by the event type specified at a specified type of management target component is occurred. In the case where the condition element indicates an event related to an apparatus itself, not the element of an apparatus, the value of the component type 1102 of the condition element may be equal to the value of the apparatus type 1101.

Moreover, the metarule 1100 includes a metarule ID 1113 that is a field to store a metarule ID for uniquely identifying metarules and a topology condition 1114 that is a field to store topology conditions to which the metarule 1100 is applied in creating an expansion rule by applying the metarule 1100 to the IT system configuration of an actual management target. In the embodiment, for the topology condition, an example is taken in which topology information is obtained from the configuration management DB 232. For example, an example of the topology condition illustrated in FIG. 11A is that the topology to which the metarule is applied is a combination of an iSCSI disk, a network I/F of a server used for providing the storage capacity of the iSCSI disk, and I/O ports of a storage device, and the I/O port of a network switch between these two I/O ports.

Furthermore, in the embodiment, in order to perform diagnosis to specify a cause event more in detail based on the conclusion derived using the metarule, the metarule 1100 includes a field 1115 that stores a metadiagnostic procedure ID, an apparatus that is the starting point of a topology to be a diagnosis target, and the conditions of the management target component. In the case where the metarule illustrated in FIG. 11 is used in failure cause analysis, a metadiagnostic procedure is used which is identified from a metadiagnostic procedure ID associated with the metarule (the metadiagnostic procedure ID described in the field 1115 of the metarule). In the example in FIG. 11A, the conditions of the identifier of the metadiagnostic procedure and the starting point are stored in the format “metadiagnostic procedure ID=(identifier), starting point=(apparatus type, component type)”. The field 1115 may store a plurality of combinations (the combinations of the conditions of the identifier of the metadiagnostic procedure and the starting point). Moreover, the fields 1115 of a plurality of the metarules 1100 may store an identifier of a single metadiagnostic procedure. A topology to be a diagnosis target may be different from a topology to which the metarule 1100 is applied. The description of a topology to be a diagnosis target will be described later.

For example, the metarule “MetaRule1” in FIG. 11A indicates as an observation event that when “a disk access response time error of the iSCSI disk 151 on the server 202” and “a transmission drop packet number error of the I/O port 271 of the network switch 203” are detected, it is concluded that a bottleneck is “a transmission drop packet number error of the I/O port 271 of the network switch 203”. Moreover, in performing analysis using the metarule “MetaRule1”, topology information to which the metarule is applied is obtained from the configuration management DB, for example, based on the conditions stored on the topology condition 1114. Furthermore, in the case where the conclusion described in the THEN section 1112 is analyzed in detail, the metadiagnostic procedure identified by “metadiagnosticProc1” is used, and is diagnosis is executed on a different topology in which the management target component fitting “the I/O port 271 of the network switch 203” is the starting point in the obtained topology information (see “starting point=(NetworkSwitch NWSwitchPort)” in the field 1115. In performing detailed analysis using the metadiagnostic procedures, a management target component in a topology to be the analysis target of the event analysis program 222 is a starting point, and the diagnosis target topology can be separately defined, so that diagnosis targets can be set including management target components around the topology to be a target for event analysis. It is noted that for the condition element included in the IF section 1111, a condition that a certain component is normal (a failure event is not occurred) may be defined. Moreover, the event type expressed by the event type 1103 of the THEN section 1112 may be newly defined, which may not be the event type of an event received by the event reception program 227.

### <Expansion Rule>

The expansion rule is information indicating the corresponding relationship between the combination of events possibly occurred on the IT system and events to be a cause candidate for a failure in the case where these events are occurred. In the first embodiment, a cause candidate defined by the expansion rule indicates a failure to be a propagation source of a system failure. The expansion rule is a rule that a topology to which the metarule 1100 is applicable is searched for a management target IT system based on the topology condition 1114 of the metarule 1100 and the rule is created as a result that the metarule 1100 is applied to the searched topology. Moreover, the expansion rule is information for use when the event analysis program 222 performs analysis.

In the embodiment, the expansion rule is described in an IF-THEN format similarly to the metarule. However, the expansion rule may be described in other formats as long as a cause event of a system failure and an observation event occurred due to the cause event are described.

FIG. 11B is an exemplary configuration of the expansion rule.

Generally, the expansion rule 1150 can be split into two portions (two fields) similarly to the metarule 1100, that is, a first portion referred to as an IF section 1151 and a second portion referred to as a THEN section 1152. The IF section 1151 may include one or more condition elements.

The expansion rule 1150 indicates that an event (a conclusion event) in the THEN section 1152 is the cause of the failure in the case where an event (a condition event) in the IF section 1151 is detected. Therefore, when the status of the management target component expressed by the THEN section 1152 becomes normal, it can be expected that a problem expressed by the IF section 1151 is solved.

In the embodiment, event information stored on the event queue table 233 illustrated in FIG. 10 expresses an observation event, and the event analysis program 222 narrows down a cause candidate for the failure. The IF section 1151 of the expansion rule 1150 individually includes entries for condition elements, and the entries include fields, an apparatus ID 1161, a component ID 1162, an event type 1163, and a reception flag 1164. Namely, the condition elements of the IF section 1151 indicate that a state indicated by information about the event type 1163 is occurred on a management target component specified by the apparatus ID 1161 and the component ID 1162. Moreover, the reception flag 1164 stores a result whether an event indicated by the condition element is actually received. In the case where an event indicated by the condition element is received, “1” is stored on the reception flag 1164, whereas in the case where an event indicated by the condition element is not received, “0” is stored on the reception flag 1164. It may be fine that after a lapse of a predetermined time since “1” is stored on the reception flag 1164, a process is performed such as a process of retuning the value to “0”, for example.

The values stored on the apparatus ID 1161 and the component ID 1162 in the IF section 1151 and the THEN section 1152 are values corresponding to the types defined at the apparatus type 1101 and the component type 1102 in the apparatus ID and the component ID specified from the configuration management DB 232 based on the topology condition 1114 of the metarule 1100.

Moreover, the expansion rule 1150 includes an expansion rule ID 1153 that is a field to store the expansion rule ID for uniquely identifying the expansion rule 1150. Furthermore, the expansion rule 1150 includes a field 1155 that stores an identifier of the metadiagnostic procedure ID, an apparatus that is the starting point of a topology to be a diagnosis target, and an identifier of a management target component in order to perform diagnosis to specify a cause event more in detail based on the conclusion derived using the expansion rule 1150. In the values stored on the field 1155, the metadiagnostic procedure ID is equal to the value stored on the field 1115 of the metarule 1100 used when the expansion rule 1150 is created. Furthermore, in the values stored on the field 1155, the apparatus ID and the component ID stored as the starting point are IDs corresponding to “the starting point condition” stored on the field 1115 of the metarule 1100 in the apparatus ID and the component ID specified from the configuration management DB 232 based on the topology condition 1114 of the metarule 1100. In the example in FIG. 11B, the values are stored in the format “metadiagnostic procedure ID=(identifier), starting point=(apparatus ID, component ID)”. FIG. 11B is expansion rules 1150a to 1150d by creating and expanding the metarule 1100 in FIG. 11A based on the configuration management DB 232 illustrated in FIGS. 3 to 8. For example, the expansion rule 1150a of “Expansion rule1” indicates that in the case where “a disk access response time error of the drive D (ID=DRIVE1) on the server A (ID=SvA)” and “a transmission drop packet number error of the port 0 (ID=SWPORT1) of the network switch D (ID=SwD)” are detected as an observation event, it is concluded that a bottleneck is “the transmission drop packet number error of the port 0 of the network switch D”. Moreover, in the case where the conclusion described in the THEN section 1152 of the expansion rule 1150a is analyzed in detail, the metadiagnostic procedure identified by “metadiagnosticProc1” is used, and diagnosis is executed on a topology in which a management target component identified by “the apparatus ID of SwD and the component ID of SWPORT1” is the starting point. It is noted that for the condition element included in the IF section 1151, a condition that a certain component is normal (a failure event is not occurred) may be defined.

### <Metadiagnostic Procedure Repository and Metadiagnostic Procedure>

The metadiagnostic procedure is a series of diagnostic procedures executed in order to specify a failure cause event after the event analysis program 222 narrows down a failure to be a propagation source of an IT system failure. The metadiagnostic procedure is configured of the step of collecting information necessary for diagnosis, the step of making a judgment based on the collected information, and a conclusion derived based on one or a plurality of the judgment results. A specific management target component to be a target for which the metadiagnostic procedures are executed is not defined, and the pattern of a topology or the pattern of a configuration to be a target for which the procedures are executed is defined.

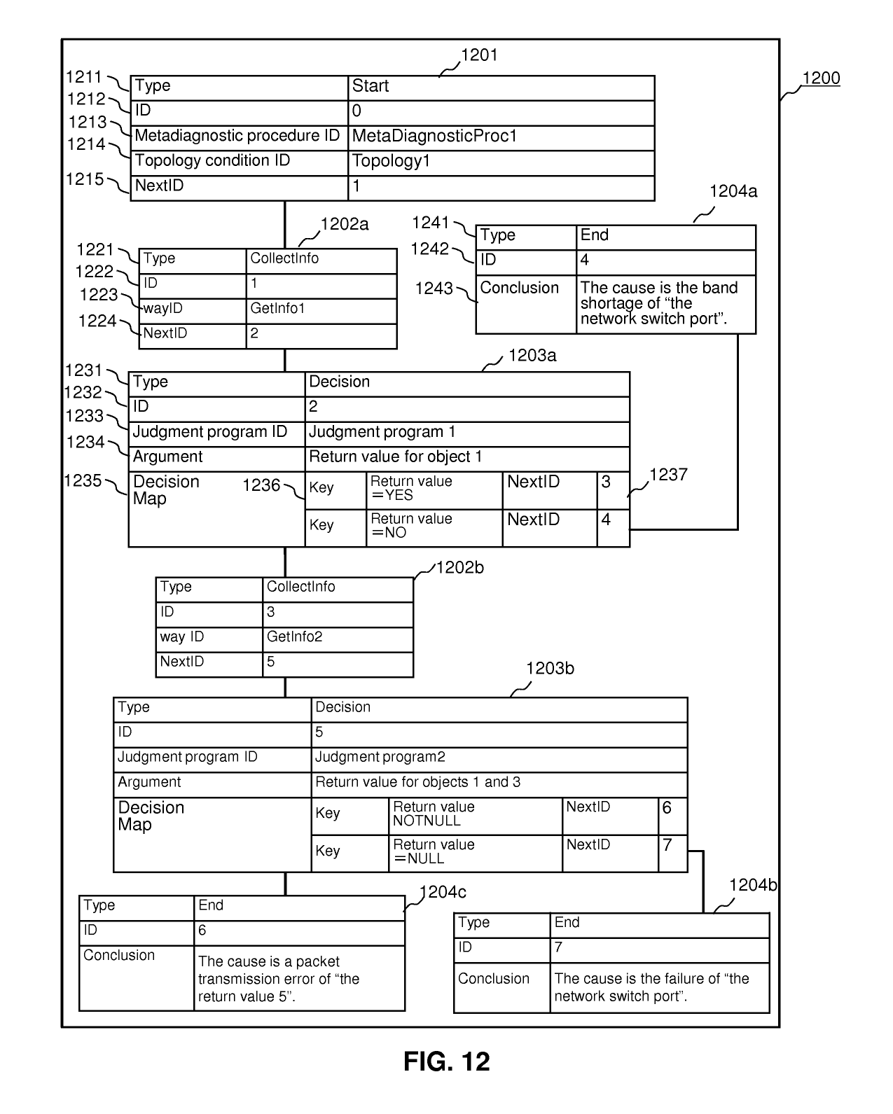

FIG. 12 is an exemplary configuration of a metadiagnostic procedure 1200 that resides on the metadiagnostic procedure repository 234.

The metadiagnostic procedure 1200 is configured of a basic object 1201 that stores information about the metadiagnostic procedure 1200, an information collection object 1202 that stores a way of collecting information necessary for diagnosis, a judgment object 1203 that stores a way of making a judgment based on the collected information, and a conclusion object 1204 that stores information about a conclusion derived based on one or a plurality of the judgment results. In the embodiment, the metadiagnostic procedure 1200 is in an object structure. However, the metadiagnostic procedure 1200 may be in a different data structure as long as it is configured of a combination of information about a way of collecting information, information about the judgment step, and information about a conclusion derived based on the judgment result. A plurality of the objects possibly exists in the object 1201 to 1204 other than the object 1201. The metadiagnostic procedure 1200 exemplified in FIG. 12 is configured of the basic object 1201, two information collection objects 1202a and 1202b, two judgment objects 1203a and 1203b, and three conclusion objects 1204a, 1204b, and 1204c.

The basic object 1201 includes five fields, that is, a type 1211, an ID 1212, a metadiagnostic procedure ID 1213, a topology condition ID 1214, and a NextID 1215. The type 1211 stores an identifier (“Start” indicating fundamental information, for example) for identifying an object type. The ID 1212 stores an identifier that uniquely identifies an object. The metadiagnostic procedure ID 1213 stores an identifier that uniquely identifies the metadiagnostic procedure 1200. The topology condition ID 1214 stores an identifier that uniquely identifies a topology condition to which the metadiagnostic procedure 1200 is applied. The NextID 1215 stores an identifier of an object that stores the step to be executed first.

The information collection object 1202 includes four fields, that is, a type 1221, an ID 1222, a way ID 1223, and a NextID 1224. The type 1221 stores an identifier for identifying an object type (“CollectInfo” indicating that the information collecting way is stored, for example). The ID 1222 stores an identifier that uniquely identifies an object similarly to the ID 1212. The way ID 1223 stores an identifier that uniquely identifies a metacollecting way. The metacollecting way necessary for diagnosis is searched for the metacollecting way repository 236 based on the identifier stored on the way ID 1223. The NextID 1225 stores the identifier of an object that stores the step to be executed next. For example, it is indicated that the information collection object 1202a obtains a metacollecting way identified by the ID “GetInfo1” from the metacollecting way repository 236 when diagnosis is executed, information is collected based on the way, and then the step indicated by the object whose ID is “2” is executed.

The judgment object 1203 includes five fields, that is, a type 1231, an ID 1232, a judgment program ID 1233, an argument 1234, and a Decision Map 1235. The type 1231 stores an identifier for identifying an object type (“Decision” indicating that information about the judgment step is stored, for example). The ID 1232 stores an identifier that uniquely identifies an object similarly to the ID 1212. The judgment program ID 1233 stores an identifier for uniquely identifying a program to make a judgment based on the collected information. The judgment program 226 that resides on the memory 212 is called based on the identifier stored on the judgment program ID. The argument 1234 stores identification information about information for use in judgment by the judgment program 226. The Decision Map 1235 stores the list of the combination of keys 1236 and NextIDs 1237. The key 1236 stores a value possibly to be the return value of the judgment program 226, and the NextID 1237 stores the identifier of the object. Namely, the Decision Map 1235 stores information for determining the step to be executed next according to the return value of the judgment program 226 when diagnosis is executed. For example, the judgment object 1203a indicates that the judgment program 226 identified by the ID of “the judgment program 1” is started when diagnosis is executed, the information collected by the object 1202a identified by the ID “1” is passed to “the judgment program 1” as the argument, and in the case where the return value of “the judgment program 1” is “YES”, the step indicated by the object 1202b identified by the ID “3” is executed, whereas in the case where the return value is “NO”, the step indicated by the object 1204a identified by the ID “4” is executed. Moreover, for an example of one judgment program, “the judgment program 1” may be “a program that it is judged whether the rise rate of performance information given as an argument is equal to or larger than a pre-defined value and YES is returned when the value is equal to or larger than the pre-defined value whereas NO is returned when the value is less than the pre-defined value, for example”.

The conclusion object 1204 includes three fields, that is, a type 1241, an ID 1242, and a Conclusion 1243. The type 1241 stores an identifier for identifying an object type (“End” indicating that information about a conclusion is stored for example). The ID 1242 stores an identifier that uniquely identifies an object similarly to the ID 1212. The Conclusion 1243 stores information to be the conclusion of diagnosis when diagnosis is executed. For example, information stored on the Conclusino 1243 may be displayed on the output device 217. For example, in the case where the conclusion object 1204a is selected as a conclusion according to the judgment result at the judgment object 1203a when diagnosis is executed, “the band shortage of “the network switch port” is displayed on the output device 217 as a diagnosed result. However, identification information about the network switch port obtained from the configuration management DB 232 based on the topology condition indicated by the topology condition ID 1214 is displayed on “the network switch port”.

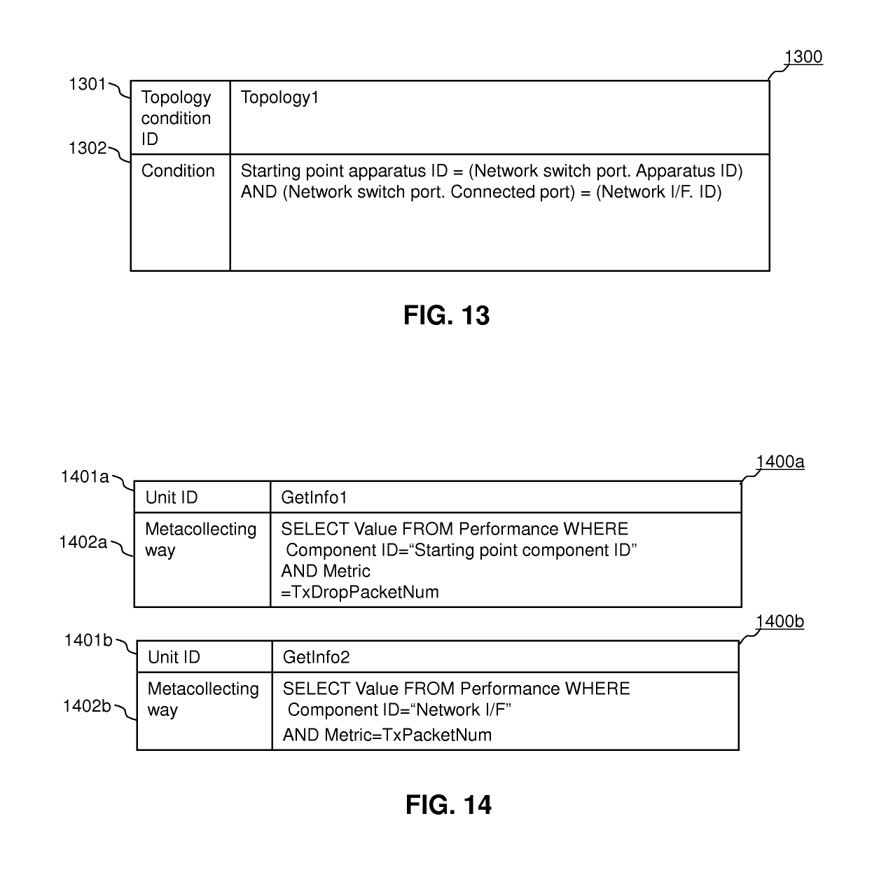

FIG. 13 is an exemplary configuration of a topology condition to which the metadiagnostic procedure 1200 is applied.

A topology condition 1300 includes two fields, that is, a topology condition ID 1301 and a condition 1302. The topology condition ID 1301 stores an identifier for uniquely identifying the topology condition. The value stored on the topology condition ID 1301 is equal to the identifier stored on the topology condition ID 1214 of the basic object 1201 in FIG. 12. The condition 1302 stores information about a topology condition to which the metadiagnostic procedure 1200 is applied. In the embodiment, a method for obtaining topology information from the configuration management DB 232 is taken as an example. For example, in the case where topology information is obtained based on the condition 1302 in FIG. 13, the following combination of the records is obtained, in which (1) the value of the apparatus ID 603 of the switch port table 600 is equal to the apparatus ID at the starting point stored on the field 1155 of the expansion rule, and (2) the value of the ID 501 of the network I/F table 500 is equal to the value of the connection destination port of the record of the switch port table 600 in (1). In other words, a topology is specified, which includes a management target component at the starting point expressed by the condition 1302 and a management target component associated with the management target component at the starting point on the condition 1302. The topology condition stored on the condition 1302 may not be in the format illustrated in FIG. 13 as long as a method for obtaining topology information is described.

### <Metacollecting Way Repository and Metacollecting Way>

FIG. 14 is exemplary configurations of metacollecting ways stored on the metacollecting way repository 236.

A metacollecting way 1400 includes two fields, that is, a way ID 1401 and a collecting way 1402.

The way ID 1401 stores an identifier for uniquely identifying the metacollecting way 1400. The value stored on the way ID 1401 is equal to the identifier stored on the way ID 1223 of the information collection object 1202 in FIG. 12. The metacollecting way 1402 stores an information collecting way necessary for diagnosis. In the embodiment, for an example of information necessary for diagnosis, performance information about the management target component that can be obtained from the performance table 238 is named. Therefore, for example, the metacollecting way 1402a stores a query for obtaining information from the table. However, since which performance information about the management target component is collected depends on the conclusion derived by the event analysis program 222, the identifier of the management target component is a variable. In the example in FIG. 14, portions enclosed with double-quotations are expressed as variables (this point is the same as the metacollecting way 1402b).

### <Expanded Diagnostic Procedure Repository and Expanded Diagnostic Procedure>

The expanded diagnostic procedure is a diagnostic procedure expanded by the diagnostic procedure expansion program 223 based on a metadiagnostic procedure and topology information. Similarly to the metadiagnostic procedure, the expanded diagnostic procedure is configured of the step of collecting information necessary for diagnosis, the step of making a judgment based on the collected information, and a conclusion derived based on one or a plurality of judgment results. A specific component to be a target for execution is not defined on the metadiagnostic procedure, whereas a component to be a target for execution is defined on the expanded diagnostic procedure based on topology information.

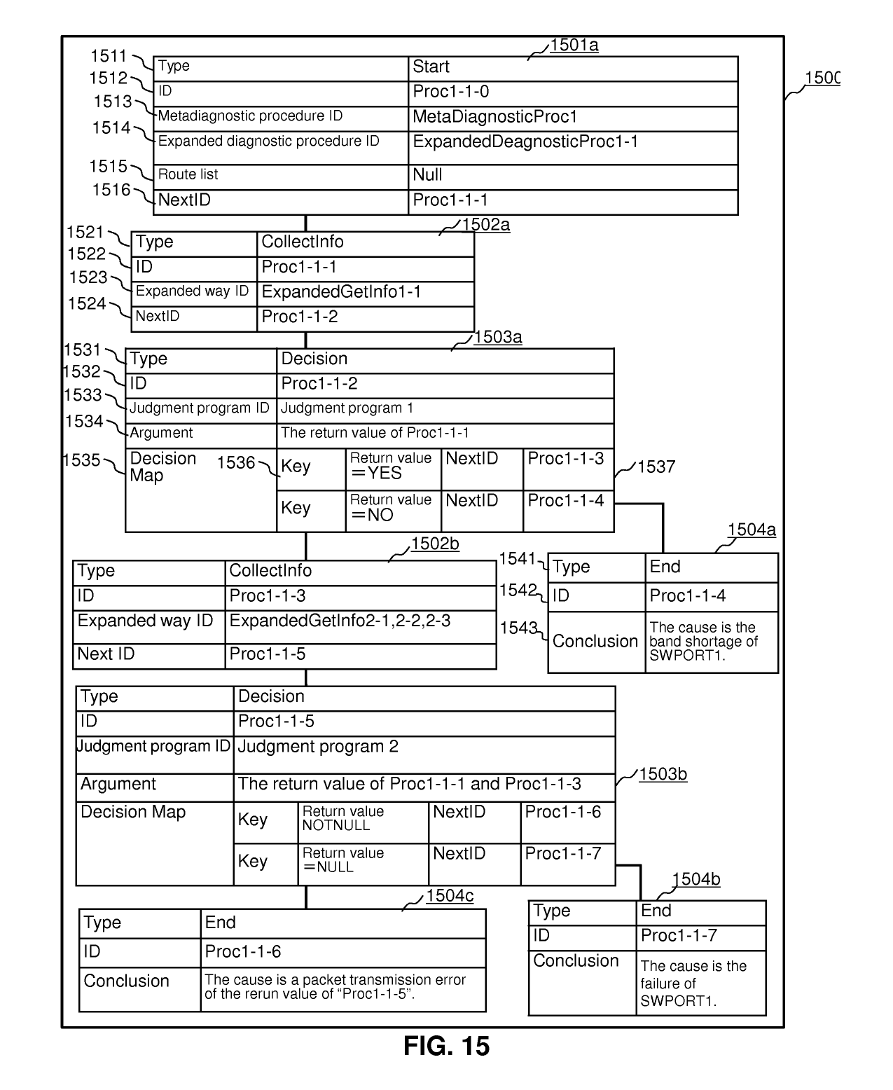

FIG. 15 is an exemplary configuration of an expanded diagnostic procedure 1500 stored on the expanded diagnostic procedure repository 235. It is noted that the expanded diagnostic procedure repository 235 is a storage repository for reusing an expanded diagnostic procedure once created in different diagnosis. The repository may not be necessarily provided on the management computer 201. Moreover, the reference numeral “124” is assigned to the expanded diagnostic procedure in FIG. 1. However, since the configuration of the expanded diagnostic procedure illustrated in FIG. 15 is different from the configuration of the expanded diagnostic procedure in FIG. 1, the expanded diagnostic procedure illustrated in FIG. 15 uses the reference numeral “1500” different from the expanded diagnostic procedure in FIG. 1. However, the expanded diagnostic procedure in FIG. 1 and the expanded diagnostic procedure illustrated in FIG. 15 may be procedures created by the same method.

The expanded diagnostic procedure 1500 is configured of a basic object 1501 that stores information about the expanded diagnostic procedure, an information collection object 1502 that stores a way of collecting information necessary for diagnosis, a judgment object 1503 that stores a way of making a judgment based on the collected information, and a conclusion object 1504 that stores information about a conclusion derived based on one or a plurality of the judgment results. In the embodiment, the expanded diagnostic procedure is in an object structure, which however may be in a different data structure as long as the expanded diagnostic procedure is configured of the combination of information about a way of collecting information, information about the judgment step, and information about a conclusion derived based on the judgment result. A plurality of the objects possibly exists in the objects 1501 to 1504 other than the object 1501. The expanded diagnostic procedure 1500 exemplified in FIG. 15 is configured of the basic object 1501, two information collection objects 1502a and 1502b, two judgment objects 1503a and 1503b, and three conclusion objects 1504a, 1504b, and 1504c.

The basic object 1501 includes six fields, that is, a type 1511, an ID 1212, a metadiagnostic procedure ID 1513, an expanded diagnostic procedure ID 1514, a route list 1515, and a NextID 1516. The type 1511 stores an identifier for identifying an object type (“Start” indicating fundamental information, for example) similarly to the type 1211 of the metadiagnostic procedure 1200. The ID 1512 stores an identifier that uniquely identifies an object. The metadiagnostic procedure ID 1513 stores an identifier of the metadiagnostic procedure 1200 used when the expanded diagnostic procedure 1500 is created. The expanded diagnostic procedure ID 1514 stores an identifier that uniquely identifies the expanded diagnostic procedure 1500. The route list 1515 stores the list of the object ID of the expanded diagnostic procedure 1500 to which reference is made when diagnosis is executed. Namely, the route list 1515 may have a data structure that can acquire a conclusion derived based on information collected for diagnosis, the judgment result, and the judgment result after executing diagnosis. The NextID 1516 stores an identifier of an object that stores the step to be executed first.

The information collection object 1502 includes four fields, that is, a type 1521, an ID 1522, an expanded way ID 1523, and a NextID 1524. The type 1521 stores an identifier for identifying an object type (“CollectInfo” indicating that the information collecting way is stored, for example) similarly to the type 1221 of the metadiagnostic procedure 1200. The ID 1522 stores an identifier that uniquely identifies an object similarly to ID 1512. The expanded way ID 1523 stores an identifier that uniquely identifies the expanded collecting way. An expanded collecting way necessary for diagnosis is searched for the expanded collecting way repository 237 based on the identifier stored on the expansion way the ID 1223. The NextID 1525 stores the identifier of the object that stores the step to be executed next. For example, the information collection object 1502a indicates that the information collecting way identified by the ID “ExpandedGetInfo1-1” is obtained from the expanded collecting way repository 237 when diagnosis is executed, information is collected based on the way, and then the step indicated by the object whose ID is “Proc1-1-2” is executed.

The judgment object 1503 includes five fields, that is, a type 1531, an ID 1532, a judgment program ID 1533, an argument 1534, and a Decision Map 1535. The type 1531 stores an identifier for identifying an object type (“Decision” indicating that information about the judgment step is stored, for example) similarly to the type 1231 of the metadiagnostic procedure 1200. The ID 1532 stores an identifier that uniquely identifies an object similarly to the ID 1512. The judgment program ID 1533 stores an identifier for uniquely identifying a program to make a judgment based on the collected information. The judgment program ID 1533 stores a value equal to the judgment program ID 1233 of the metadiagnostic procedure 1200. The judgment program 226 that resides on the memory 212 is called based on the identifier stored on the judgment program ID. The argument 1534 stores identification information about information for use in judgment by the judgment program 226. The Decision Map 1535 stores the list of the combination of keys 1536 and NextIDs 1537 similarly to the Decision Map 1235 of the metadiagnostic procedure 1200. The key 1536 stores a value possibly to be the return value of the judgment program 226, and the NextID 1537 stores the identifier of the object. Namely, the Decision Map 1535 stores information for determining the step to be executed next according to the return value of the judgment program 226 when diagnosis is executed. For example, the judgment object 1503a indicates that the judgment program 226 identified by the ID of “the judgment program 1” is started when diagnosis is executed, the information collected by the object 1502a identified by the ID “Proc1-1-1” as an argument is passed to “the judgment program 1”, and in the case where the return value of “the judgment program 1” is “YES”, the step indicated by the object 1502b identified by the ID “Proc1-1-3” is executed, whereas in the case where the return value is “NO”, the step indicated by the object 1504a identified by the ID “Proc1-1-4” is executed.

The conclusion object 1504 includes three fields, that is, a type 1541, an ID 1542, and a Conclusion 1543. The type 1541 stores an identifier for identifying an object type (“Conclusion” indicating that information about the conclusion is stored, for example) similarly to the type 1241 of the metadiagnostic procedure 1200. The ID 1542 stores an identifier that uniquely identifies an object similarly to the ID 1512. The Conclusion 1543 stores information to be a conclusion of diagnosis when diagnosis is executed. For example, information stored on the Conclusion 1543 may be displayed on the output device 217. For example, in the case where the conclusion object 1504a is selected as a conclusion according to the judgment result of the judgment object 1503 when diagnosis is executed, “the band shortage of SWPORT1 (the port 0 of the network switch D)” is displayed on the output device 217 as a diagnosed result.

### <Expanded Collecting Way Repository and Expanded Collecting Way>

The expanded collecting way is an information collecting way expanded by the diagnostic procedure expansion program. 223 based on the metaexpanded collecting way and topology information. A specific component to be a target for information collection is not defined on the metacollecting way.

In the embodiment, a component is expressed by a variable. On the contrary, a component to be a target for information collection is defined on the expanded collecting way based on topology information.

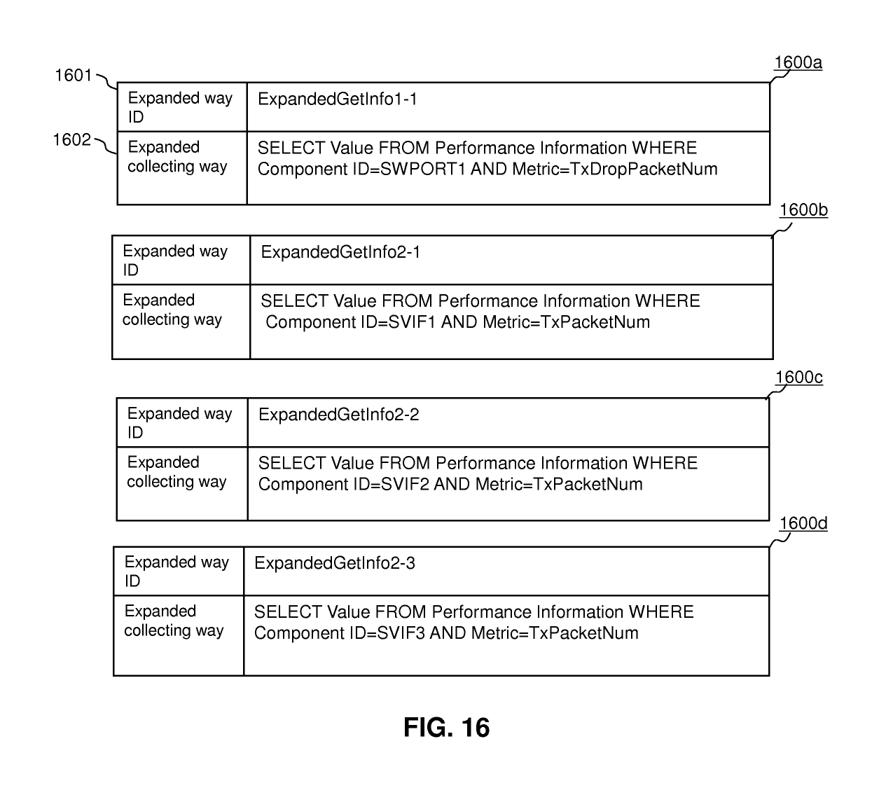

FIG. 16 is exemplary configurations of expanded collecting ways stored on the expanded collecting way repository 237.

The expanded collecting way 1600 includes two fields, that is, an expanded way ID 1601 and an expanded collecting way 1602. The expanded way ID 1601 stores an identifier for uniquely identifying the expanded collecting ways. The value stored on the expanded way ID 1601 is equal to the identifier stored on the expanded way ID 1523 of the information collection object 1502 in FIG. 15. The expanded collecting way 1602 stores an information collecting way necessary for diagnosis. In the embodiment, for an example of information necessary for diagnosis, performance information about the management target component that can be obtained from the performance table 238 is named. Therefore, for example, the expanded collecting way 1602a stores a query for obtaining information from the table. The same thing is similarly applied to the other expanded collecting ways 1602b, 1602c, and 1602d. As different from the metacollecting way 1402, the expanded collecting way 1602 defines a target for information collection. FIG. 16 is examples of the expanded collecting ways 1600a to 1600d created by expanding the metacollecting way 1400 in FIG. 14 based on the topology condition 1300a in FIG. 13.

### <Process of Failure Analysis Program>

In the embodiment, after failure cause analysis is executed based on the pattern of events, diagnosis is executed based on the result in order to specify a more detailed failure cause event.

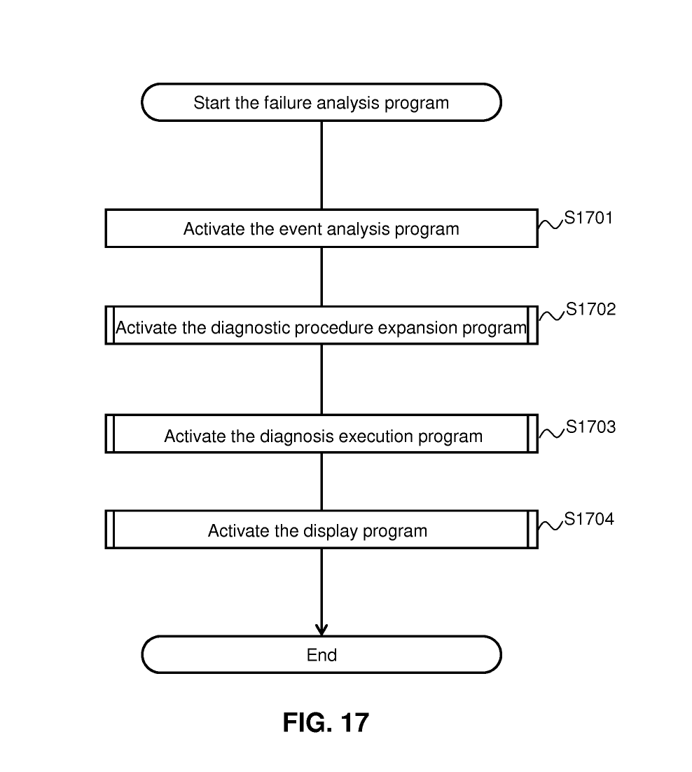

FIG. 17 is a flowchart of an exemplary failure cause analysis process executed by the failure analysis program 221.

The failure analysis program 221 may be configured in which a failure is occurred on the IT system, the event reception program 227 detects an event related to the failure, and then the process is started. Moreover, this process may be started in which an administrator detects the occurrence of a failure on the IT system and the failure analysis program 221 is started by the indication of the administrator through the input device 214.

In Step S1701, the failure analysis program 221 executes the event analysis program 222. The event analysis program 222 performs a process of narrowing down a failure cause event based on the pattern of events occurred. In the embodiment, the event analysis program 222 narrows down a candidate of a failure to be a propagation source of a system failure based on an event information group stored on the event queue table 233, the metarule stored on the metarule repository 231, and configuration information stored on configuration management DB 232. For example, in the case where the event reception program 227 receives an event information group of the event queue table 233 illustrated in FIG. 10 and the event analysis program 222 performs analysis based on the metarule 1100 illustrated in FIG. 11A and the tables illustrated in FIGS. 3 to 8, the expansion rules 1150a, 1150b, 1150c, and 1150d are created. Then, for example, based on information on the THEN sections 1152 of the expansion rules 1150a and 1150b, the event analysis program 222 derives a conclusion that “the propagation source of the failure is a transmission drop packet number error (the identifier of the event type is TxDropPacketNumError) of the port 0 (whose ID is SWPORT1) of the network switch D (whose ID is SwD)”.

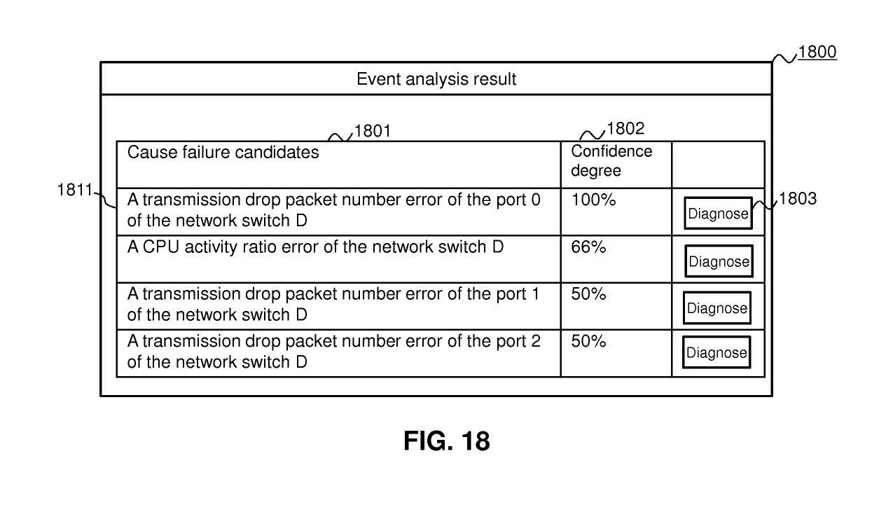

FIG. 18 is an exemplary event analysis result screen 1800.

The event analysis result screen 1800 is a screen that a conclusion derived by the event analysis program 222 is presented as failures to be a propagation source of a plurality of failures occurred on the IT system for cause candidates. The event analysis result screen 1800 may individually include entries for failure cause candidates to be a propagation source, and the entries include a cause failure candidate field 1801 that displays failure cause candidates, a confidence degree field 1802 that displays the probabilities (the confidence degrees) of the cause candidates indicated on the field 1801, and a diagnosis execution button 1803. The confidence degree displayed on the confidence degree field 1802 may be the event reception rate of the expansion rule 1150 related to the cause candidate 1811, for example. For example, the event reception rate may be calculated in Equation “the event reception rate=(the condition element number whose reception flag 1164 is “1”)/(the total number of the condition elements)”.

In the case where a plurality of expansion rules exists for a single cause candidate 1811, values based on a plurality of event reception rates individually corresponding to a plurality of the expansion rules (for example, the maximum value, the mean value, or the minimum value of the event reception rate) may be displayed on the confidence degree field 1802.

Alternatively, it may be fine that the event reception rate is calculated based on the total number of the condition elements of all the expansion rules related to the cause candidate 1811 and the condition element number whose reception flag 1164 is “1” and the calculated value is displayed on the confidence degree field 1802. Moreover, a plurality of cause candidates may be displayed in descending order of confidence degrees based on the conclusion derived by the event analysis program 222.

When the administrator presses down the execution button 1803 corresponding to a desired cause candidate, the process goes to Step S1702 in FIG. 17 in order to perform detailed diagnosis of the corresponding cause candidate, and the diagnostic procedure expansion program 223 is started. The input interface for executing detailed diagnosis by the administrator is not limited to the button, and any input interfaces to indicate the execution of diagnosis to the management computer 201 can be adopted. Furthermore, it may be fine that the diagnostic procedure expansion program 223 is automatically executed to the derived cause candidates after the event analysis program 222 derives the cause candidates, not by the indication of the administrator. Moreover, in the case where the diagnostic procedure expansion program 223 is automatically executed, it may be fine that the diagnostic procedure expansion program 223 is executed on the cause candidates whose confidence degree is equal to or larger than a certain value in the cause candidates derived by the event analysis program 222.

In the embodiment, a conclusion derived by the event analysis program 222 indicates a failure to be a propagation source of a plurality of failures occurred on the IT system. The administrator presses down the diagnosis execution button 1803, and the diagnostic procedure expansion program 223 is started in response to the pressing in order to execute diagnosis to specify the cause of the occurrence of the failure to be the propagation source.

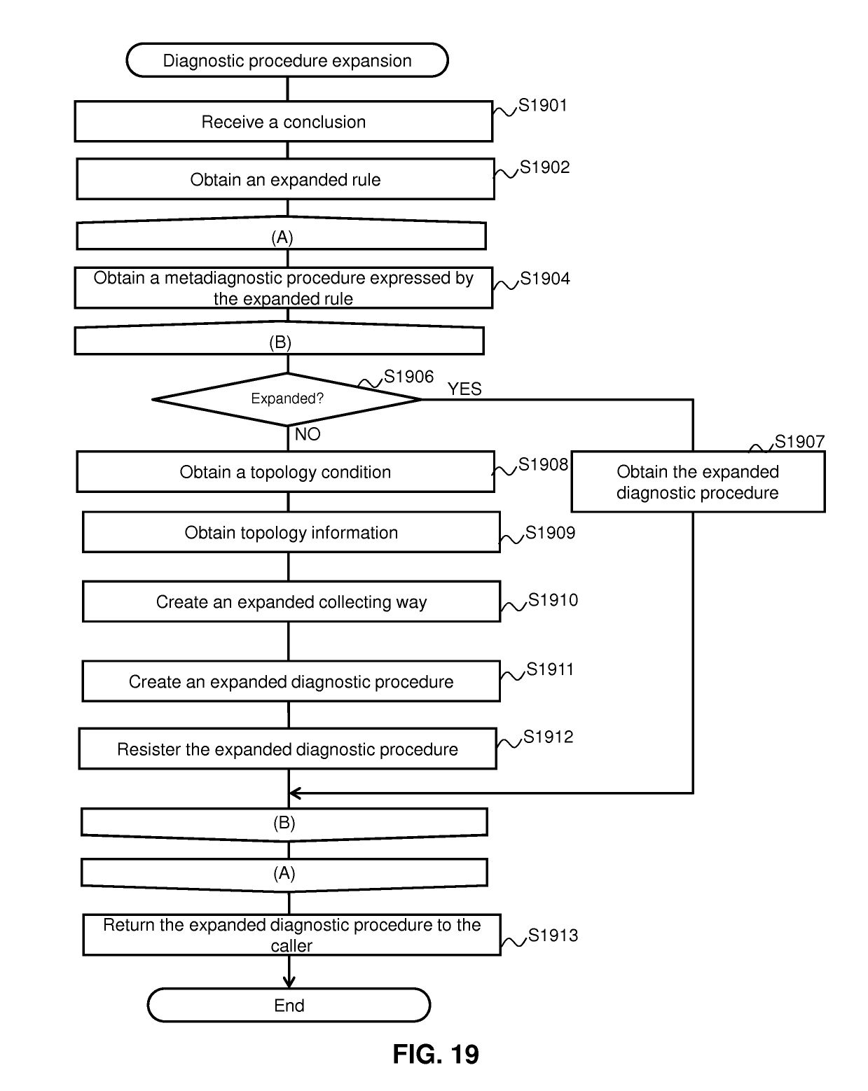

In Step S1702, the failure analysis program 221 starts the diagnostic procedure expansion program 223 as the input is information about the selected cause candidate in Step S1701. The diagnostic procedure expansion program creates the expanded diagnostic procedure 1500 based on information about the input cause candidate, that is, information about the THEN section 1152 of the expansion rule 1150, the expansion rule 1150, the metadiagnostic procedure 1200, the metacollecting way 1400, and configuration information stored on configuration management DB 232. An example of a detailed process of the diagnostic procedure expansion program 223 is illustrated in FIG. 19.

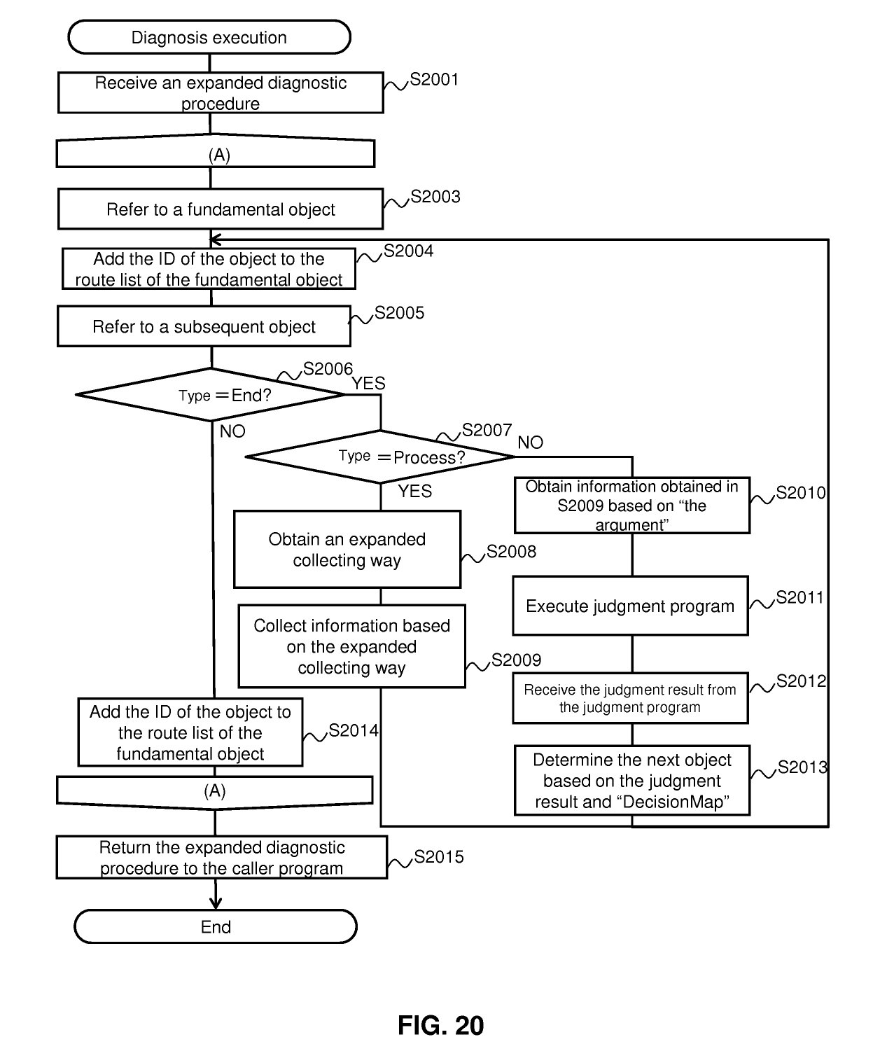

In Step S1703, the failure analysis program 221 starts the diagnosis execution program 224 as the input is the expanded diagnostic procedure 1500. The diagnosis execution program 224 performs diagnosis based on the expanded diagnostic procedure 1500, and specifies a failure cause event on the IT system. An example of a detailed process of the diagnosis execution program 224 is illustrated in FIG. 20.

In Step S1704, the failure analysis program 221 starts the display program 225 as the input is the expanded diagnostic procedure 1500 diagnosed in Step S1703. The display program 225 displays information about the cause of the failure derived in Step S1703 on the output device 217 based on the input expanded diagnostic procedure 1500 and the route list 1515 of the input expanded diagnostic procedure 1500.

In the embodiment, the diagnostic procedure expansion program 223 is executed after the event analysis program 222 is executed. However, the diagnostic procedure expansion program 223 may be executed before executing the event analysis program 222. For example, it may be fine that the diagnostic procedure expansion program 223 extracts all cause candidates possibly derived by the event analysis program 222 based on configuration information about the configuration management DB 232 and the metarule 1100, the expanded diagnostic procedure 1500 and the expanded collecting way 1600 necessary to diagnose these cause candidates are created based on the metadiagnostic procedure 1200, the metacollecting way 1400, and configuration information about the configuration management DB 232, and the expanded diagnostic procedure 1500 and the expanded collecting way 1600 are stored on the expanded diagnostic procedure repository 235 and the expanded collecting way repository 237. In this case, the failure analysis program 221 executes the event analysis program 222, obtains the expanded diagnostic procedure 1500 for the cause candidate derived by the event analysis program 222 from the expanded diagnostic procedure repository 235, and starts the diagnosis execution program 224 as the input is the obtained expanded diagnostic procedure 1500.

Moreover, in the embodiment, an example is taken in which the diagnosis execution program 224 collects information necessary for diagnosis and the judgment program 226 executes judgment. However, it may be fine that after executing Step S1702, the created expanded diagnostic procedure 1500 is passed to the display program 225, the display program 225 displays the expanded diagnostic procedure 1500 on the output device 217, and the administrator preforms the process as the expanded diagnostic procedure 1500.

### <Process of Diagnostic Procedure Expansion Program>

FIG. 19 is a flowchart of an exemplary process executed by the diagnostic procedure expansion program 223 (Step S1702).

In Step S1901, the diagnostic procedure expansion program 223 receives information about the conclusion derived by the event analysis program 222 as a cause candidate for the failure. Information about the conclusion may be the combination of items of information stored on the THEN section 1152 of the expansion rule 1150. For example, the diagnostic procedure expansion program 223 receives information indicating “a transmission drop packet number error (the identifier of the event type is TxDropPacketNumError) of the port 0 (whose ID is SWPORT1) of the network switch D (whose ID is SwD)”.

In Step S1902, the diagnostic procedure expansion program 223 obtains the expansion rule 1150 related to information about the conclusion received in Step S1901. Namely, the diagnostic procedure expansion program 223 obtains the expansion rule 1150 including the received conclusion in the THEN section 1152. The diagnostic procedure expansion program 223 performs the processes in Steps S1904 to S1912 on all the expansion rules 1150 obtained in Step S1902. In the following, a single expansion rule (“a target expansion rule” in the following description in FIG. 19) 1150 is taken as an example.

In Step S1904, the diagnostic procedure expansion program 223 obtains the metadiagnostic procedure 1200 identified by the metadiagnostic procedure ID stored on the field 1155 of the target expansion rule 1150 from the metadiagnostic procedure repository 234. The diagnostic procedure expansion program 223 performs the processes in Steps S1906 to S1912 on all the metadiagnostic procedures 1200 obtained in Step S1904. In the following, a single metadiagnostic procedure (“a target metadiagnostic procedure” in the following description in FIG. 19) 1200 is taken as an example.

In Step S1906, the diagnostic procedure expansion program 223 judges whether the target metadiagnostic procedure 1200 is already expanded at the starting point indicated by the field 1155 of the target expansion rule 1150. In the case where the judgment result is true (YES in S1906), the process goes to Step S1907, whereas in the case where the judgment result is false (NO in S1906), the process goes to Step S1908.

In Step S1907, the diagnostic procedure expansion program 223 obtains the expanded diagnostic procedure 1500 expanded based on the target metadiagnostic procedure indicated by the field 1155 of the target expansion rule 1150 and the starting point from the expanded diagnostic procedure repository 235.

In Step S1908, the diagnostic procedure expansion program 223 obtains the topology condition 1300 identified by the identifier stored on the topology condition ID 1214 of the basic object 1201 of the target of the metadiagnostic procedure 1200.

In Step S1909, the diagnostic procedure expansion program 223 obtains topology information from the configuration management DB 232 based on information stored on the condition 1302 of the topology condition 1300 obtained in Step S1908. The topology expressed by the obtained topology information has the starting point of the management target component (the apparatus or the element of the apparatus) indicated by “the starting point” in the field 1155 of the target expansion rule 1150. For example, in the case where the target expansion rule 1150 is the expansion rule 1150a in FIG. 11B, the starting point is a management target component whose apparatus ID is “SwD” and whose component ID is “SWPORT1”. Moreover, in the case where the topology condition 1300 is the topology condition 1300a in FIG. 13, the diagnostic procedure expansion program 223 refers to the record on which the apparatus ID 603 of the switch port table 600 is “SwD” (the records on the first to fourth lines) and refers to the record (the records on the second to fourth lines) on which the ID 501 of the network I/F table 500 is equal to the value stored on the connection destination port 604 on these records, and obtains the combination of the referenced record IDs (three sets of SWPORT1-SWPORT2-SVIF1, SWPORT1-SWPORT3-SVIF2, and SWPORT1-SWPORT4-SVIF3) as topology information.

Furthermore, in topology information that can be obtained using the topology condition 1300, the topology on which a failure event is not occurred on management target components (or the apparatus configured of the management target components) other than a management target component to be a starting point may be omitted from topology information obtained in Step S1909. Whether a failure event is occurred on the management target component may be judged whether an event related to the failure is occurred within a certain time period from the time point at which the event reception program 227 detects a failure event triggered to start analysis. Thus, the diagnosis target can be restricted to the topology on which a failure is occurred. In addition, the expanded diagnostic procedure 1500 may be created for individual topologies or a single expanded diagnostic procedure 1500 may be created for all topologies obtained based on a set of the topology condition and the starting point.

In Step S1910, the diagnostic procedure expansion program 223 obtains the metacollecting way 1400 identified by the identifier stored on the way ID 1223 of the information collection object 1202 of the metadiagnostic procedure 1200 from the metacollecting way repository 236. The diagnostic procedure expansion program 223 then expands the metacollecting way 1400 based on the topology information obtained in Step S1909, and creates the expanded collecting way 1600. The ID in the topology information is substituted into the variable in the metacollecting way 1400, and the expanded collecting way 1600 is created (the expanded collecting way 1602 is as illustrated in FIG. 16, for example).

In Step S1911, the diagnostic procedure expansion program 223 creates the expanded diagnostic procedure 1500 based on the metadiagnostic procedure 1200, the topology information obtained in Step S1909, and the expanded collecting way 1600 created in Step S1910.

In Step S1912, the diagnostic procedure expansion program 223 registers the expanded diagnostic procedure 1500 created in Step S1911 to the expanded diagnostic procedure repository 235.

In Step S1913, the diagnostic procedure expansion program 223 returns the expanded diagnostic procedure 1500 created or obtained from the expanded diagnostic procedure repository 235 to the program of calling source.

It is noted that in Step S1904, in the case where the event reception rate of the target expansion rule 1150 is equal to or less than a certain value, it may be fine that the target expansion rule is out of the target for expanding the metadiagnostic procedure related to the expansion rule and for executing diagnosis. Thus, the expanded diagnostic procedure executed by the diagnosis execution program 224 can be restricted to the expanded diagnostic procedure related to the expansion rule whose event reception rate is equal to or larger than a certain value, and executing unnecessary diagnosis can be reduced.

A specific example of the process in FIG. 19 is as follows. In Step S1901, in the case of receiving information of “the transmission drop packet number error (the identifier of the event type is TxDropPacketNumError) of the port 0 (whose ID is SWPORT1) of the network switch D (whose ID is SwD)” as the conclusion of the event analysis program 222, the diagnostic procedure expansion program 223 obtains the expansion rules 1150a and 1150b in FIG. 11B in Step S1902. When the expansion rule 1150a is taken as an example, the diagnostic procedure expansion program 223 obtains the metadiagnostic procedure 1200 in FIG. 12 in Step S1904. In Step S1906, in the case where it is judged that it is not expanded, the diagnostic procedure expansion program 223 obtains the topology condition 1300a in FIG. 13 in Step S1908. In Step S1909, the diagnostic procedure expansion program 223 obtains three items of topology information (SWPORT1-SWPORT2-SVIF1, SWPORT1-SWPORT3-SVIF 2, and SWPORT1-SWPORT4-SVIF3). Since “GetInfo1” and “GetInfo2” are stored on the way Ids 1223 of two information collection objects 1202 of the metadiagnostic procedure 1200, the diagnostic procedure expansion program 223 creates the expanded collecting way 1600a based on the metacollecting way 1400a and topology information in FIG. 14, and creates the expanded collecting ways 1600b, 1600c, and 1600d based on the metacollecting way 1400b and topology information in Step S1910. In Step S1911, the diagnostic procedure expansion program 223 creates the expanded diagnostic procedure 1500 illustrated in FIG. 15 from the metadiagnostic procedure 1200 and the obtained topology information. In Step S1912, the diagnostic procedure expansion program 223 then stores the expanded diagnostic procedure 1500 on the expanded diagnostic procedure repository 235, and in Step S1913, the diagnostic procedure expansion program 223 returns the created expanded diagnostic procedure 1500 to the failure analysis program 221.

### <Process of Diagnosis Execution Program>

FIG. 20 is a flowchart of an exemplary process executed by the diagnostic procedure expansion program 223 (Step S1703).

In Step S2001, the diagnosis execution program 224 receives the expanded diagnostic procedure 1500. The diagnosis execution program 224 repeats the processes in Steps S2003 to S2014 to all the expanded diagnostic procedures received in Step S2001. In the following, a single expanded diagnostic procedure (in the following, in the description in FIG. 20, “a target expanded diagnostic procedure”) is taken as an example.

In Step S2003, the diagnosis execution program 224 refers to a basic object 1501 whose type is “Start” in the objects configuring a target expanded diagnostic procedure 1500.

In Step S2004, the diagnosis execution program 224 adds the ID of the object to which reference is made to the route list 1515 of the basic object 1501.

In Step S2005, the diagnosis execution program 224 refers to an object subsequent to the object to which reference is made. In the case where the object to which reference is made is the basic object 1501 or the information collection object 1502, the diagnosis execution program 224 refers to an object whose ID is stored on the NextID 1516 or the NextID 1524. In the case where reference is made to the judgment object 1503, the diagnosis execution program 224 determines the subsequent object based on the Decision Map 1535 in Step S2013 described later.

In Step S2006, the diagnosis execution program 224 judges whether the type of the object to which reference is made in Step S2005 is “End”. In the case where this judgment result is true (YES in S2006), the process goes to Step S2007, whereas in the case where this judgment result is false (NO in S2006), the process goes to Step S2014.

In Step S2007, the diagnosis execution program 224 judges whether the type of the object to which reference is made in Step S2005 is “CollectInfo”. In the case where the judgment result is true (YES in S2007), the process goes to Step S2008, whereas in the case where the judgment result is false (NO in S2007), the process goes to Step S2010.

In Step S2008, the diagnosis execution program. 224 obtains the expanded collecting way 1600 identified by the identifier stored on the expanded way ID 1523 of the object to which reference is made from the expanded collecting way repository 237.

In Step S2009, the diagnosis execution program. 224 obtains information from the repository included in the management target apparatus or the management computer 201 based on the expanded collecting way obtained in Step S2008.

In Step S2010, the diagnosis execution program. 224 obtains information collected in Step S2009 based on information stored on the argument 1534 of the object to which reference is made.

In Step S2011, the diagnosis execution program 224 starts the judgment program 226 identified by the identifier stored on the judgment program ID 1533 of the object to which reference is made as the input is the information obtained in Step S2010.

In Step S2012, the diagnosis execution program 224 receives the judgment result from the judgment program 226 executed in Step S2011.

In Step S2013, the diagnosis execution program 224 obtains the NextID 1537 stored on the Decision Map 1535 of the object to which reference is made using the judgment result received in Step S2012 as a key, and determines an object to which reference is made next.

In Step S2014, the diagnosis execution program 224 adds the ID of the object to which reference is made to the route list 1515 of the basic object 1501.

In Step S2015, the diagnosis execution program 224 returns the received expanded diagnostic procedure 1500 to the program of calling source.

A specific example of the process in FIG. 20 is as follows. For example, in Step S2001, in the case of receiving the expanded diagnostic procedure 1500 illustrated in FIG. 15, the diagnosis execution program 224 refers to the basic object 1501a in Step S2003, and adds the object ID “Proc1-1-0” to the route list 1515 in Step S2004. Subsequently, in Step S2005, the diagnosis execution program 224 refers to the information collection object 1502 based on the identifier “Proc1-1-1” indicated by the NextID 1516. Since the type of the information collection object 1502a is “CollectInfo”, the process goes to Step S2008. In Step S2008, the diagnosis execution program 224 obtains the expansion information way 1600a in FIG. 16 based on the expanded way ID “ExpandedGetInfo1-1”. The diagnosis execution program 224 then collects information from the performance table 238 based on a SQL query described in the expanded collecting way 1602. Returning to Step S2004, the diagnosis execution program 224 adds the object ID “Proc1-1-1” to the route list 1515. Subsequently, since the object to which reference is made in Step S2005 is the judgment object 1503a, the process goes to Step S2010. In Step S2010, the diagnosis execution program 224 obtains the performance information obtained based on the expansion information way 1600a, and in Step S2011, the diagnosis execution program 224 starts “the judgment program 1” as the input is the performance information. In Step S2012, in the case of receiving the value “NO” from “the judgment program 1”, the diagnosis execution program 224 determines that the object to which reference is made next is the conclusion object 1504a including the ID “Proc1-1-4” based on the Decision Map 1535. Again returning to Step S2004, the diagnosis execution program 224 adds the object ID “Proc1-1-3” to the route list 1515, and refers to the conclusion object 1504a in Step S2005. Since the type of the conclusion object 1504a is “End”, the process goes to Step S2014, and the diagnosis execution program 224 adds the object ID “Proc1-1-4” to the route list 1515. The diagnosis execution program 224 then returns the expanded diagnostic procedure 1500 on which the route list 1515 is updated to the failure analysis program 221 of calling source.

With the processes described above, the diagnosis execution program 224 can perform diagnosis in order to specify the cause event of a failure occurred on the IT system based on the expanded diagnostic procedure created by the diagnostic procedure expansion program 223.

It is noted that it may be fine that the diagnosis execution program 224 displays the collected information on the output device 217 in Step S2009, the judgment program 226 executed in Step S2011 displays the judgment criteria and an input interface (a button, for example) to which the administrator inputs the judgment result on the output device 217, and the judgment result received in Step S2012 is the judgment result input by the administrator through the input interface.

Moreover, in the case where the diagnosis execution program 224 is not enabled to acquire information for use in judgment in Step S2010, the judgment program 226 returns a plurality of judgment results in Step S2011, the diagnosis execution program 224 continuers the diagnostic procedures individually for a plurality of the judgment results and refers to a plurality of the conclusion objects 1504, and the display program 225 displays a plurality of cause events based on a plurality of the conclusion objects 1504.

Furthermore, it may be fine that the diagnosis execution program 224 does not perform the information collection process based on the information collection object 1502 and judgment of the judgment program 226 based on the judgment object 1503 in order of the objects of the expanded diagnostic procedure, and performs the process and the judgment in parallel with each other.

### <Process of Display Program>

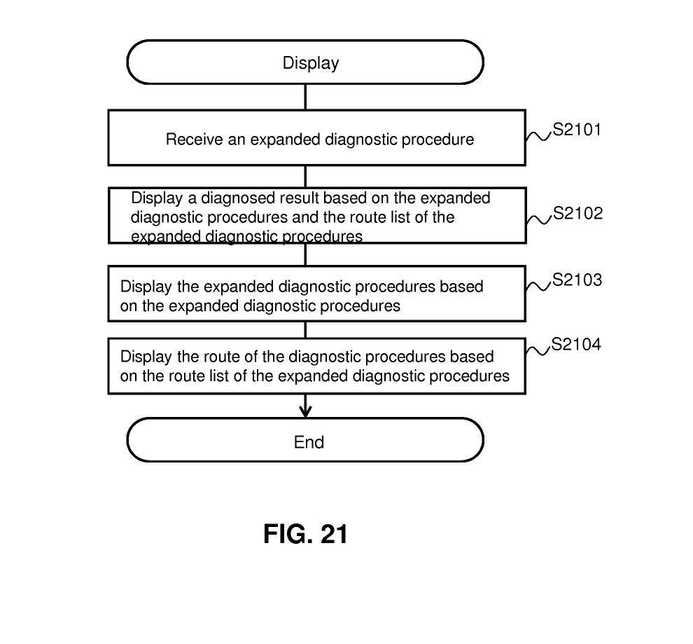

FIG. 21 is a flowchart of an exemplary process executed by the display program 225 (Step S1704).

In Step S2101, the display program 225 receives the expanded diagnostic procedure 1500.

In Step S2102, the display program 225 obtains the conclusion object 1504 to which the diagnosis execution program 224 finally refers based on the received expanded diagnostic procedure 1500 and the list stored on the route list 1515 of the basic object 1501, and displays the conclusion object 1504 as a diagnosed result.

In Step S2103, the display program 225 displays the used diagnostic procedures based on the received expanded diagnostic procedure.

In Step S2104, the display program 225 displays the executed procedure in the diagnostic procedures used by the diagnosis execution program 224 based on the route list 1515 of the basic object 1501 of the received expanded diagnostic procedure 1500.

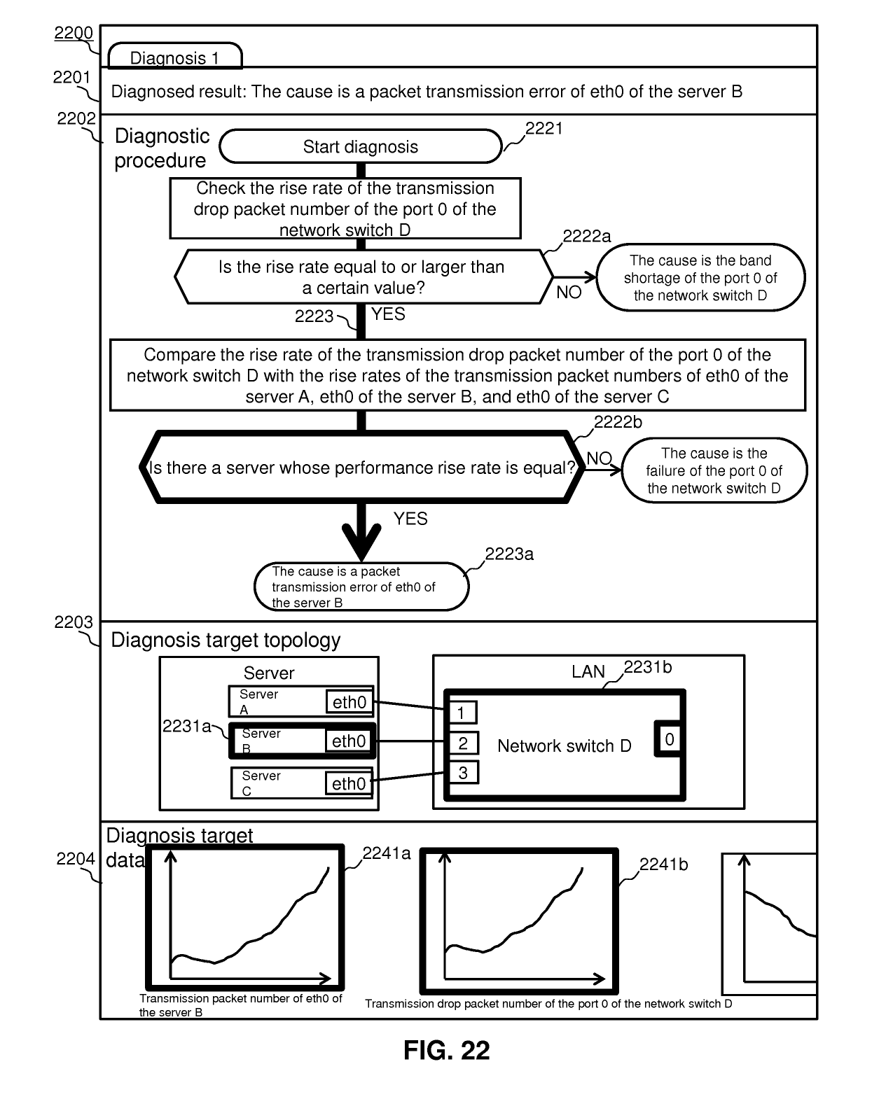

It is noted that information is in turn displayed in the Steps 2101 to S2104. However, instead of this, it may be fine that the display program 225 writes display target information on the memory 212 and displays a screen including these display targets (a screen in FIG. 22, for example) in the case where all of display targets are written on the memory 212.

FIG. 22 is an exemplary diagnosis result screen.

A diagnosis result screen 2200 is a screen on which the diagnostic procedures that the diagnosis execution program. 224 is executed and their diagnosed results are displayed, and is displayed on the output device 217. More specifically, this screen 2200 shows the expanded diagnostic procedure illustrated in FIG. 15 and the result that the procedure is executed. The diagnosis result screen 2200 may be configured of a diagnosed result field 2201 on which the diagnosed result derived by the diagnosis execution program 224 is displayed and a diagnostic procedure field 2202 that displays information about the expanded diagnostic procedure 1500 used by the diagnosis execution program 224. Moreover, the diagnosis result screen 2200 may include a diagnosis target topology field 2203 that displays information about the diagnosed topology and a diagnosis target data field 2204 that displays information collected when diagnosis is executed and used for judgment.

Information displayed on the diagnosed result field 2201 is an example of information (a diagnosed result) displayed by the display program 225 in Step S2102. The conclusion object 1504 to which the diagnosis execution program 224 finally refers is obtained based on the route list 1515 of the received expanded diagnostic procedure 1500, and the conclusion object 1504 is displayed on the field 2201 as a diagnosed result.

Information displayed on the diagnostic procedure field 2202 is an example of information (a diagnostic procedure) displayed by the display program 225 in Step S2103. The diagnosis execution program 224 obtains the used diagnostic procedures based on information about the received expanded diagnostic procedure 1500, and the diagnostic procedures are displayed on the field 2202. In FIG. 22, as an exemplary display of the diagnostic procedures, the value indicated by the argument 1534 of the judgment object 1503, the judgment criteria by the judgment program 226 identified from the judgment object 1503, and information about the conclusion derived by the conclusion object 1504 are displayed. The route 2223 in FIG. 22 is an example of “the executed procedure” displayed by the display program 225 based on the route list 1515 in Step S2104. As illustrated in FIG. 22, a portion indicating a flow of “the executed procedure” (an arrow) may be highlighted to the diagnostic procedures 2221 or the list of the executed procedures may be displayed.

Information displayed on the diagnosis target topology field 2203 is information expressing a topology to be a target for the expanded diagnostic procedure 1500. It may be fine that the diagnostic procedure expansion program 223 stores topology information on a storage area such as the memory 212 of the management computer 201 in association with the expanded diagnostic procedure 1500 in the process in FIG. 19 and the display program 225 displays the stored information on the field 2203 when the display program 225 is started.

The diagnosis target data field 2204 displays information obtained when the diagnosis execution program 224 refers to the information collection object 1502 of the expanded diagnostic procedure 1500. It may be fine that the diagnosis execution program 224 stores information obtained in the process in FIG. 20 in Step S2009 on a storage area such as the memory 212 of the management computer 201 in association with the expanded diagnostic procedure 1500 and the display program. 225 displays the stored information on the field 2204 when the display program 225 is started.

Moreover, information about the management target component that is a judgment target may be displayed individually for the judgment procedures on the diagnosis target topology field 2203. For example, in the exemplary display in FIG. 22, it may be fine that when the administrator selects a judgment display 2222 on which the judgment criteria of the judgment object 1503 are displayed, information about the management target component that is set for judgment target by the judgment program 226 is highlighted in association with the judgment object 1503. For example, in the case where the administrator selects a judgment display 2222a that displays the judgment criteria of the judgment object 1503a, information indicated by the argument 1534 of the judgment object 1503a is “the return value for Proc1-1-1”, and information collected by the procedure “Proc1-1-1” is performance information about “the port 0 of the network switch D (the identifier is SWPORT1)”, so that “the port 0 of the network switch D” may be highlighted.

Furthermore, information about the management target component to be the element for determining the judgment result may be displayed individually for the judgment procedures on the diagnosis target topology field 2203. For example, in the exemplary display in FIG. 22, it may be fine that when the administrator selects the judgment display 2222 on which the judgment criteria of the judgment object 1503 of the expanded diagnostic procedure 1500 are displayed, information about the management target component to be the element for determining the judgment result is highlighted in the management target components displayed on the diagnosis target topology field 2203. For example, the judgment object 1503b related to the judgment display 2222b is the object of the expanded diagnostic procedure 1500 including judgment information in which “the rise rate of the transmission drop packet number of the port 0 of the network switch D is compared with the rise rates of the transmission packet numbers of eth0 of the server A, eth0 of the server B, and eth0 of the server C, and in the case where there is any one server whose rise rate is equal to the transmission drop packet number of the port 0 of the network D, reference is made to the conclusion object 1504c related to the conclusion display 2223a, or reference is made to the conclusion object 1504b”. Then, in the case where only the server B includes the rise rate equal to the rise rate of the transmission drop packet number of the port 0 of the network switch D, the diagnosis execution program 224 refers to the conclusion object 1504c. In this case, “eth0 of the server B (the identifier is SVIF2)” to be the factor of referring to the conclusion object 1504c and “the port 0 of the network switch D (the identifier is SWPORT1)” to be the target for comparison may be highlighted. It may be fine that information obtained in Step S2010 and the judgment result in Step S2012 when the diagnosis execution program 224 is executed are stored on a storage area such as the memory 212 of the management computer 201, and these items of information are displayed. When the judgment object 1503b is taken as an example, “the judgment program 2” indicated by the judgment program ID 1533 is called for judgment. In the case where “the judgment program 2” is a program that returns a set of IDs of the components whose rise rates of performance information are equal, it may be fine that the return value of “the judgment program 2” is stored on a storage area such as the memory 212 of the management computer 201 and the display program 225 displays information about the management target components having the IDs.

Moreover, information to be a target for judgment may be displayed individually for the judgment procedures on the diagnosis target data field 2204. For example, in the exemplary display in FIG. 22, it may be fine that when the administrator selects the judgment display 2222 on which the judgment criteria of the judgment object 1503 are displayed, information indicating the argument 1534 of the judgment object 1503 is highlighted. For example, it may be fine that in the case where the administrator selects the judgment display 2222a on which the judgment criteria of the judgment object 1503a are displayed, information 2241b indicating the argument 1534 of the judgment object 1503a is highlighted.

Furthermore, information about the element for determining the judgment result may be displayed individually for the judgment procedures on the diagnosis target data field 2204. For example, in the exemplary display in FIG. 22, it may be fine that when the administrator selects the judgment display 2222 on which the judgment criteria of the judgment object 1503 of the expanded diagnostic procedure 1500 are displayed, information about the element for determining the judgment result is highlighted in information displayed on the diagnosis target data field 2204. For example, the judgment object 1503b related to the judgment display 2222b is the object of the expanded diagnostic procedure 1500 including judgment information in which “the rise rate of the transmission drop packet number of the port 0 of the network switch D is compared with the rise rates of the transmission packet numbers of eth0 of the server A, eth0 of the server B, and eth0 of the server C, and in the case where there is any one server whose rise rate is equal to the transmission drop packet number of the port 0 of the network D, reference is made to the conclusion object 1504c related to the conclusion display 2223a, or reference is made to the conclusion object 1504b”. Then, in the case where only the server B includes the rise rate equal to the rise rate of the transmission drop packet number of the port 0 of the network switch D, the diagnosis execution program 224 refers to the conclusion object 1504c. In this case, “performance information about the transmission packet number of eth0 of the server B (the identifier is SVIF2)” to be a factor for referring to the conclusion object 1504c and “performance information about the transmission drop packet number of the port 0 of the network switch D (the identifier is SWPORT1)” to be a target for comparison may be highlighted. It may be fine that information obtained in Step S2010 and the judgment result in Step S2012 when the diagnosis execution program 224 is executed are stored on a storage area such as the memory 212 of the management computer 201, and these items of information are displayed.

In addition, it may be fine that in the case where a plurality of expanded diagnostic procedures is executed on a single cause candidate derived by the event analysis program 222, the diagnosed result screen is displayed individually for the expanded diagnostic procedures.

Moreover, it may be fine that when information collected in Step S2009 is stored on a storage area such as the memory 212 of the management computer 201 for a certain period and the step of collecting the same information is executed on the same management target component in executing different diagnosis, the diagnosis execution program 224 uses information already stored on a storage area such as the memory 212. It may be fine that when collected information is displayed on the output device 217, the collecting time point is displayed.

Furthermore, it may be fine that when the judgment result received in Step S2012 is stored on a storage area such as the memory 212 of the management computer 201 for a certain period and when judgment is made based on the same information about the same management target component in executing different diagnosis, the diagnosis execution program 224 does not execute the judgment program, and uses the stored judgment result. It may be fine that when the judgment result is displayed on the output device 217, the judged time point is displayed.

As described above, according to the first embodiment, it is possible that related diagnosis is executed on the cause failure candidate derived by the event analysis program 222, information necessary for diagnosis is collected in diagnosis, judgment is made on the collected information, and the cause event of the failure is specified using the conclusion consequently obtained. Thus, it is possible that the administrator quickly specifies the cause event of the failure and the downtime caused by an IT system failure can be shortened.

### Second Embodiment

Next, a second embodiment will be described. In the following description, differences from the first embodiment will be mainly described, and the description of equivalent components, programs including equivalent functions, and tables including equivalent items will be omitted or simplified.

In the first embodiment, diagnosis is executed on a failure to be a propagation source of a plurality of failures derived by the event analysis program, and the conclusion obtained by diagnosis is presented as the cause of the occurrence of the failure to be a propagation source. The method exemplified in the first embodiment is effective for investigating a more detailed cause after specifying a cause in a range that can be revealed by the event analysis program. On the other hand, for an effective use method for diagnosis in addition to this, it can be named that the accuracy of the confidence degree for the cause candidate derived by the event analysis program is improved (the value of the confidence degree is increased, for example).

In the second embodiment, an example will be described in which an event analysis program derives cause candidates, diagnosis is executed, and the diagnosed result is reflected on the confidence degree of the cause candidate derived by an event analysis function.

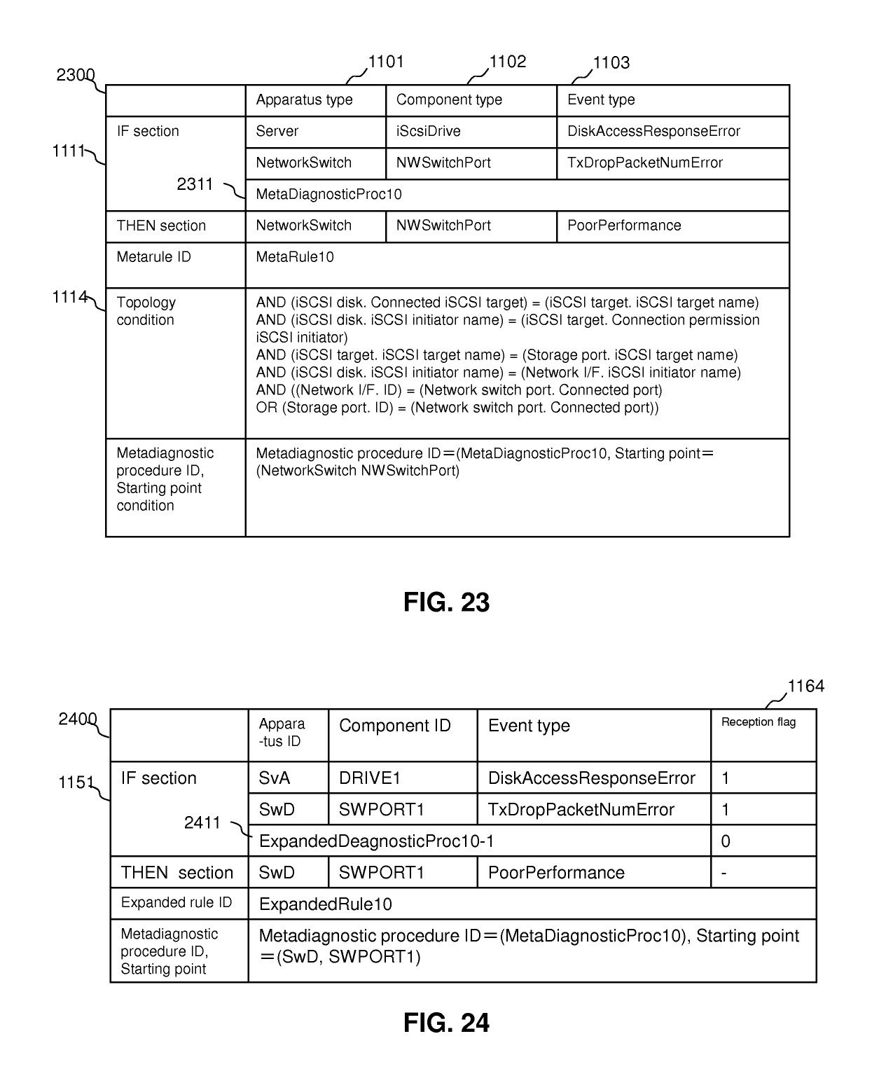

FIG. 23 is an exemplary configuration of a metarule 2300 according to the second embodiment.

The configuration of the metarule 2300 according to the second embodiment is substantially the same as the configuration of the metarule 1100 according to the first embodiment. In the metarule 1100 according to the first embodiment, the condition element 1121 configuring the IF section 1111 is configured of the apparatus type 1101, the component type 1102, and the event type 1103 in order that the event reception program 227 stores the received event type. On the contrary, the metarule 2300 according to the second embodiment may include a field 2311 that stores an identifier of the metadiagnostic procedure 1200 as the condition element of the IF section 1111 in order to reflect the diagnosed result.

FIG. 24 is an exemplary configuration of an expansion rule 2400 according to the second embodiment.

The configuration of the expansion rule 2400 according to the second embodiment is substantially the same as the configuration of the expansion rule 1150 according to the first embodiment. Similarly to the metarule, in the expansion rule 1150 according to the first embodiment, the condition element of the IF section 1151 is configured of the apparatus ID 1161, the component ID 1162 and the event type 1163 in order to store events that the event reception program. 227 possibly receives. On the contrary, the expansion rule 2400 according to the second embodiment may include a field 2411 that stores an identifier of an expanded diagnostic procedure as the condition element of the IF section 1151 in order to reflect the diagnosed result.

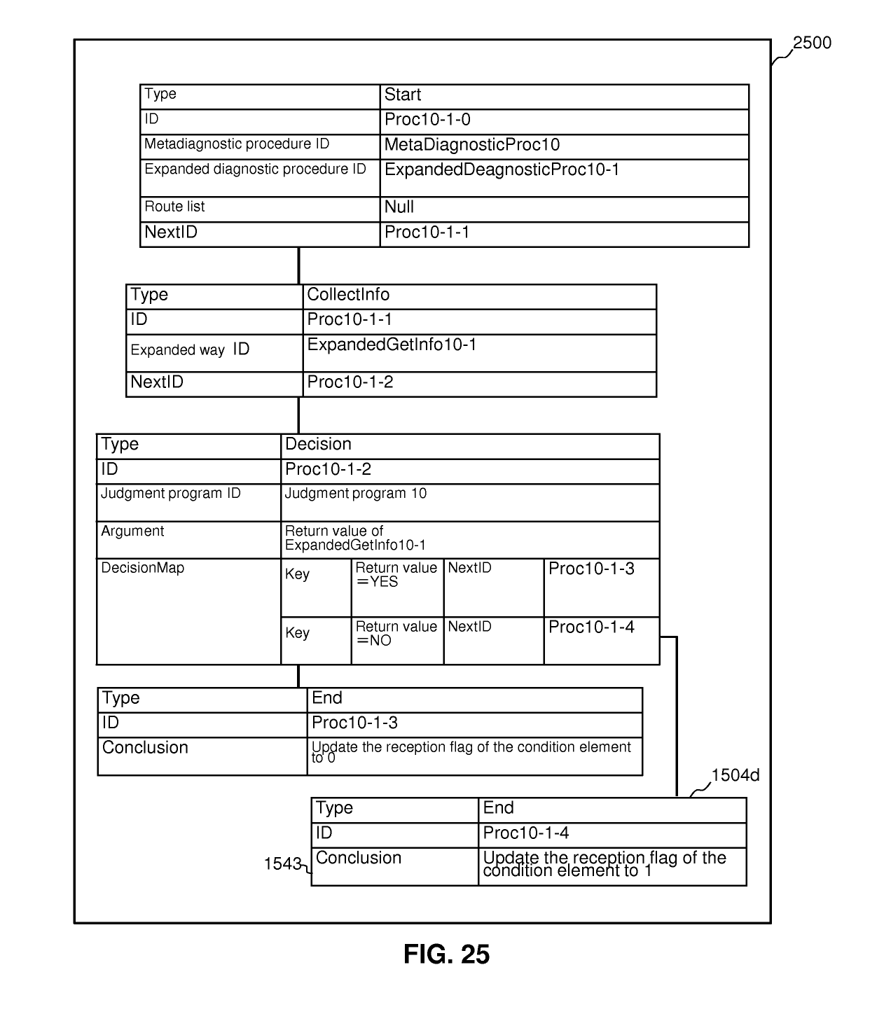

FIG. 25 is an exemplary configuration of an expanded diagnostic procedure according to the second embodiment.

The configuration of an expanded diagnostic procedure 2500 according to the second embodiment is substantially the same as the configuration of the expanded diagnostic procedure 1500 according to the first embodiment. The expanded diagnostic procedure 2500 may store an indication on the Conclusion 1543 of the conclusion object 1504, and the indication updates the reception flag 1164 corresponding to the field 2411 that stores an identifier of the expanded diagnostic procedure of the expansion rule 2400 in order to reflect the diagnosed result.

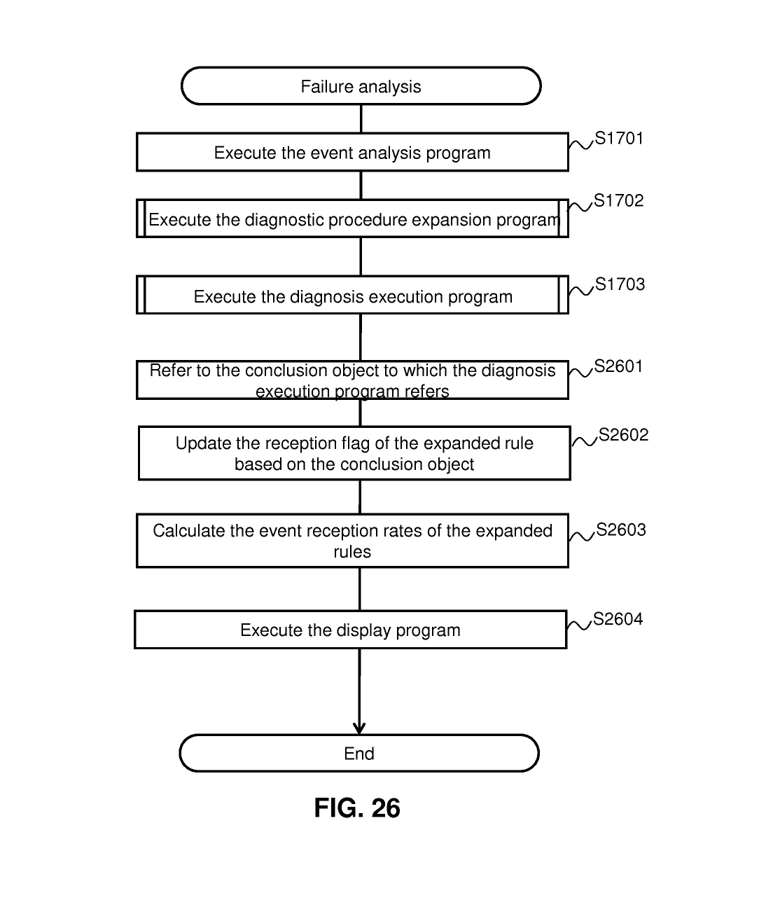

FIG. 26 is a flowchart of an exemplary failure cause analysis process executed by the failure analysis program 221 according to the second embodiment. The timing of starting the failure analysis program. 221 may be the timing described in the first embodiment.

In Step S1701, the failure analysis program 221 executes the event analysis program 222. The process to be executed is the same as the process in Step S1701 described in the first embodiment.

In Step S1702, the failure analysis program 221 starts the diagnostic procedure expansion program 223 as the input is information about a cause candidate selected in Step S1701. The process to be executed is substantially the same as the process in Step S1702 described in the first embodiment or the process in FIG. 19. However, the diagnostic procedure expansion program 223 creates the expanded diagnostic procedure 2500 in Step S1909, and obtains the expansion rule 2400 obtained in Step S1902 and the metarule 2300 that is the basis of the expansion rule 2400. In the case where the created expanded diagnostic procedure 2500 includes a metadiagnostic procedure ID the same as the identifier of the metadiagnostic procedure stored on the condition element field 2311 of the metarule 2300, the diagnostic procedure expansion program 223 stores the expanded diagnostic procedure ID on the field 2411 of the condition element of the expansion rule 2400 in association with the metarule 2300.

It is noted that in the case where the expanded diagnostic procedure is created based on topology information having the value of the component ID of the IF section of the expansion rule as the starting point, it may be fine that the diagnostic procedure expansion program 223 stores the expanded diagnostic procedure ID on the field 2411 of the condition element as limited to the expansion rule having the ID of the component to be the starting point. Moreover, it may be fine that the diagnostic procedure expansion program. 223 stores the expanded diagnostic procedure ID on the field 2411 of the expansion rule as limited to the case where topology information obtained in creating the expanded diagnostic procedure is equal to topology information obtained in creating the expansion rule.

In Step S1703, the failure analysis program 221 starts the diagnosis execution program 224 as the input is the expanded diagnostic procedure. The process to be executed is the same as the process in Step S1703 described in the first embodiment.

In Step S2601, the failure analysis program 221 receives an expanded diagnostic procedure from the diagnosis execution program 224, and refers to the conclusion object 1504 of the expanded diagnostic procedure 2400 to which the diagnosis execution program 224 refers based on the route list 1515 of the expanded diagnostic procedure.

In Step S2602, the failure analysis program 221 searches the expansion rule that includes the expanded diagnostic procedure ID of the expanded diagnostic procedure 2400 received from the diagnosis execution program 224 in the condition element, and then updates the reception flag 1164 of the condition element 2411 of the expansion rule 2400 as the indication stored on the Conclusion 1543 of the conclusion object 1504 to which reference is made in Step S2601.

For example, in the case where the expanded diagnostic procedure received from the diagnosis execution program 224 refers to a conclusion object 1504d in Step S2061 in the expanded diagnostic procedure 2500 in FIG. 25, the failure analysis program 221 updates the reception flag 1164 corresponding to the field 2411 of the condition element of the expansion rule 2400 including the ID “ExpandedDeagnosticProc10-1” of the expanded diagnostic procedure 2500 in the condition element to “1”.

In Step S2603, the failure analysis program 221 calculates the event reception rates of the expansion rules. As decried in the first embodiment, the calculation expression of the event reception rate may be “the event reception rate=(the condition element number whose reception flag 1164 is “1”)/(the total number of the condition elements)”.

In Step S2604, the failure analysis program 221 starts a display program 225. The display program 225 updates the confidence degree of the cause candidate selected in Step S1701 on the event analysis result screen 1800 based on the event reception rate calculated in Step S2603.

As described above, according to the second embodiment, the related diagnosis is executed on the cause candidate derived by the event analysis program, and the confidence degree of the cause candidate is updated using the conclusion consequently obtained, so that it is possible that a more probable failure cause candidate is presented to the administrator in priority. Accordingly, it is possible that the administrator quickly specifies the cause of the failure.

Hereinabove, some embodiments are described. However, the present invention is not limited to these embodiments. For example, it may be fine that the metadiagnostic procedure 1200 includes the metarule ID of the metarule 1100 and the starting point associated with the metadiagnostic procedure 1200 instead of or in addition to the metarule 1100 including the metadiagnostic procedure ID of the metadiagnostic procedure 1200 and the starting point associated with the metarule 1100. With any configurations, the metarule 100 can be associated with the metadiagnostic procedure 1200 in many-to-many correspondence.

### REFERENCE SIGNS LIST

201: Management computer

1. A management system that analyzes a cause of one or more occurrence events that are one or more events occurred on one or more management target components in a plurality of management target components, the management system comprising:
a storage device; and
a processor coupled to the storage device,
wherein the storage device is configured to store configuration management information, a plurality of rules, and a plurality of multi-purpose diagnostic procedures,
wherein the configuration management information is information about a configuration of the plurality of management target components,
wherein each of the plurality of rules is a rule that indicates an association between one or more condition events and a conclusion event to be a cause when the one or more condition events are occurred,
wherein each of the plurality of multi-purpose diagnostic procedures is associated with any one of the plurality of rules, and is a multi-purpose diagnostic procedure that is defined using one or a plurality of component types and that does not depend on a management target component, and
the processor is configured to
specify one or more cause candidates based on one or more target rules that are one or more rules in association with one or more condition events related to the one or more occurrence events in the plurality of rules; and
specify a multi-purpose diagnostic procedure in association with a target rule that is a basis of a selected cause candidate in the one or more cause candidates in the plurality of multi-purpose diagnostic procedures, and create an expanded diagnostic procedure that is a diagnostic procedure to be executed on one or more management target components for specifying a more specific cause of the selected cause candidate or updating a certainly of the selected cause candidate based on the specified multi-purpose diagnostic procedure and the configuration management information.

2. The management system according to claim 1,
wherein the processor is configured to display information expressing the created expanded diagnostic procedure.

3. The management system according to claim 1,
wherein the processor is configured to create the expansion diagnosis way to a topology that is a topology specified based on the specified multi-purpose diagnostic procedure and the configuration management information and that has a management target component to be a target for one or more condition events in the one or more target rules or a management target component to be a target for one or more conclusion events in the one or more target rules as a starting point.

4. The management system according to claim 1,
wherein the processor is configured to create the expanded diagnostic procedure based on information about the one or more occurrence events in addition to the specified multi-purpose diagnostic procedure and the configuration management information.

5. The management system according to claim 1,
wherein each of the plurality of multi-purpose diagnostic procedures is a combination of one or more information collection definitions, one or more judgment definitions, and a plurality of conclusion definitions,
wherein each of the one or more information collection definitions expresses information collection and an information collection source component type,
wherein each of the one or more judgment definitions expresses that a judgment is made based on collected information, and corresponds to at least one of at least one conclusion definition and at least one information collection definition as a judgment result,
wherein each of the one or more conclusion definitions expresses a conclusion, and
wherein at least one judgment definition is associated with at least one conclusion definition.

6. The management system according to claim 5,
wherein the expanded diagnostic procedure is created by associating a component type of the specified multi-purpose diagnostic procedure with a management target component corresponding to the component type based on the configuration management information, and
wherein the processor is configured to determine a conclusion based on the expanded diagnostic procedure and display the determined conclusion.

7. The management system according to claim 1,
wherein the processor is configured to take a multi-purpose diagnostic procedure in association with a target rule that is a basis of the selected cause candidate for a basis of creating an expanded diagnostic procedure only when a ratio of a condition event fitting an occurrence event in one or more condition events in association with a target rule that is a basis of the selected cause candidate is equal to or larger than a certain value.

8. The management system according to claim 6,
wherein the processor is configured to display at least one of an executed definition and collected information.

9. The management system according to claim 1,
wherein the processor is configured to calculate a confidence degree for each of the one or more cause candidates based on a target rule that is a basis of the selected cause candidate and the one or more occurrence events, and
wherein the processor is configured to select a cause candidate to be a diagnosis target in the one or more cause candidates based on the calculated one or more confidence degrees.

10. The management system according to claim 5,
wherein the processor is configured to calculate a confidence degree for the each of one or more cause candidates based on a target rule that is a basis of the selected cause candidate and the one or more occurrence events,
wherein a part of conclusion definitions in the plurality of conclusion definitions expresses that the calculated confidence degree is updated, and
the processor is configured to determine a conclusion based on the expanded diagnostic procedure and update a confidence degree of the selected cause candidate when the determined conclusion is updating a confidence degree.

11. The management system according to claim 5,
wherein the processor is configured to display the expanded diagnostic procedure, then accept an input of information expressing a result of a judgment expressed by the expanded diagnostic procedure, and determine a definition to perform based on the judgment result expressed by the accepted information.

12. The management system according to claim 5,
wherein the processor is configured to display the expanded diagnostic procedure, and then display information satisfying a judgment result in information collected based on the expanded diagnostic procedure.

13. The management system according to claim 5,
wherein the processor is configured to write, on the storage device, at least one of information and a collecting time point collected in executing the expanded diagnostic procedure and a judgment result and a judgment time point in executing the expanded diagnostic procedure, and when information collection or judgment is information collection or judgment on a management target component the same as information or a judgment result written on the storage device in executing a different expanded diagnostic procedure and a lapse of a certain time period is not passed since a collecting time point or a judgment time point written on the storage device, the processor is configured to handle the information or judgment result stored on the storage device as collection information or a judgment result in the different expanded diagnostic procedure.

14. A method for supporting analysis of a cause of one or more occurrence events that is one or more events occurred on one or more management target components in a plurality of management target components, the method comprising:
specifying one or more cause candidates based on one or more target rules that are one or more rules in association with one or more condition events related to the one or more occurrence events in a plurality of rules indicating an association between one or more condition events and a conclusion event to be a cause when the one or more condition events are occurred;
specifying a multi-purpose diagnostic procedure in association with a target rule that is a basis of a selected cause candidate in the one or more cause candidates in a plurality of multi-purpose diagnostic procedures that is a multi-purpose diagnostic procedure which is associated with any one of the plurality of rules and defined using one or a plurality of component types and which does not depend on a management target component; and
creating an expanded diagnostic procedure that is a diagnostic procedure to be executed on one or more management target components for specifying a more specific cause of the selected cause candidate or updating a certainly of the selected cause candidate based on the specified multi-purpose diagnostic procedure and configuration management information that is information about a configuration of the plurality of management target components.

15. A computer program that causes a computer to execute:
specifying one or more cause candidates based on one or more target rules that are one or more rules in association with one or more condition events related to the one or more occurrence events in a plurality of rules indicating an association between one or more condition events and a conclusion event to be a cause when the one or more condition events are occurred;
specifying a multi-purpose diagnostic procedure in association with a target rule that is a basis of a selected cause candidate in the one or more cause candidates in a plurality of multi-purpose diagnostic procedures that is a multi-purpose diagnostic procedure which is associated with any one of the plurality of rules and defined using one or a plurality of component types and which does not depend on a management target component; and
creating an expanded diagnostic procedure that is a diagnostic procedure to be executed on one or more management target components for specifying a more specific cause of the selected cause candidate or updating a certainly of the selected cause candidate based on the specified multi-purpose diagnostic procedure and configuration management information that is information about a configuration of the plurality of management target components.
